(19) United States
(12) Patent Application Publication
(10) Pub. No.: US 2011/0006591 A1
(43) Pub. Date: Jan. 13, 2011

(54) BRAKING APPARATUS

(75) Inventors: Yuji Yoshii, Shizuoka-ken (JP); Chiaki Hamada, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi, Aichi (JP)

(21) Appl. No.: 12/919,309

(22) PCT Filed: Dec. 2, 2008
(86) PCT No.: PCT/JP08/71896

§ 371 Date: Aug. 25, 2010

(30) Foreign Application Priority Data
Mar. 4, 2008 (JP) 2008-053686

(51) Int. Cl. B60T 13/52; B60T 13/66; G06F 19/00; B60T 13/72; B60T 13/46

(52) U.S. Cl. 303/4; 188/355; 701/70; 188/356

(57) ABSTRACT

A braking apparatus includes a braking mechanism that increases operating force to a brake operating member by a brake servo, generates braking force exerted on wheels corresponding to the increased operating force, and is capable of holding the braking force when a vehicle stops, and a controller that executes braking force holding control to hold the braking force when an operation amount of the brake operating member corresponding to the operating force becomes larger than a control start judgment value, and sets the control start judgment value to be smaller than the control start judgment value in a normal state of the brake servo when the brake servo fails. The braking force can be appropriately held.

### TECHNICAL FIELD

The present invention relates to a braking apparatus, and specifically relates to the braking apparatus for generating braking force exerted on wheels of a vehicle by operation of a brake pedal.

### BACKGROUND ART

Conventionally, the vehicle is provided with the braking apparatus capable of braking the moving vehicle, and the braking apparatus generates required braking force required by a driver for the braking apparatus on the wheels of the vehicle by the operation of the brake pedal by the driver. As such conventional braking apparatus, for example, a brake controlling apparatus of the vehicle disclosed in the Patent Document 1 is the brake controlling apparatus of the vehicle for controlling the braking force applied to the wheels by a predetermined braking apparatus operated based on brake operation by the driver, provided with a vehicle speed detecting means that detects a speed of the vehicle, a brake operation detecting means that detects a brake operation amount of the driver in the predetermined braking apparatus, and a braking force holding means that holds the braking force in a case in which the vehicle speed detecting means detects that the vehicle speed becomes not higher than a predetermined vehicle speed, when a first brake operation amount of the driver in the predetermined braking apparatus is detected by the brake operation detecting means and thereafter a second brake operation amount of the driver in the predetermined braking apparatus larger than the first brake operation amount is detected. That is to say, the conventional braking apparatus executes control to hold the braking force when a master cylinder pressure as the brake operation amount generated by the master cylinder corresponding to the brake operation of the driver becomes larger than a predetermined value by further depression of the brake pedal after the vehicle stops. According to this, the brake controlling apparatus of the vehicle according to the Patent Document 1 executes the control to hold the braking force of the vehicle even when the driver does not perform the brake operation at the time of hill start, for example, by simple operation intended by the driver.

Patent Document 1: Japanese Patent Application Laid-open No. 2006-213287

### DISCLOSURE OF INVENTION

### Problems to be Solved by the Invention

However, the brake controlling apparatus of the vehicle disclosed in the above-described Patent Document 1 is provided with a brake booster for increasing pedal force input to the brake pedal by using an engine negative pressure, for example, and when the brake booster fails due to deficiency of the negative pressure supplied to the brake booster, increase in the pedal force by the brake booster becomes smaller or the device is out of control, so that the master cylinder pressure generated by the master cylinder corresponding to the pedal force might drastically decrease. Therefore, when the brake booster fails due to the deficiency of the negative pressure supplied to the brake booster and the like, for example, the pedal force larger than that in a normal state of the brake booster might be required in order to increase the master cylinder pressure to the predetermined value. In other words, when the brake booster fails, for example, the further depression of the pedal is difficult and operation of the control to hold the braking force might be difficult.

Therefore, an object of the present invention is to provide the braking apparatus capable of appropriately holding the braking force.

### Means for Solving Problem

In order to achieve the above mentioned object, a braking apparatus according to claim 1 includes a braking means that increases operating force to a brake operating member by a brake servo means, generates braking force exerted on wheels corresponding to the increased operating force, and is capable of holding the braking force when a vehicle stops; and a controlling means that executes braking force holding control to hold the braking force when an operation amount of the brake operating member corresponding to the operating force becomes larger than a control start judgment value, and sets the control start judgment value to be smaller than the control start judgment value in a normal state of the brake servo means when the brake servo means fails.

The braking apparatus according to claim 2 includes an operating force detecting means that detects the operating force input to the brake operating member; and an operation amount detecting means that detects an operation amount of the brake operating member corresponding to the operating force, wherein the controlling means has a fail detecting means that detects fail of the brake servo means based on the operating force detected by the operating force detecting means and the operation amount detected by the operation amount detecting means, and a judgment value setting means that sets the control start judgment value based on a detection result of the fail detecting means.

In order to achieve the above mentioned object, a braking apparatus according to claim 3 includes a braking means that increases operating force to a brake operating member by a brake servo means by using a negative pressure, generates braking force exerted on wheels corresponding to the increased operating force, and is capable of holding the braking force when a vehicle stops; and a controlling means that executes braking force holding control to hold the braking force when an operation amount of the brake operating member corresponding to the operating force becomes larger than a control start judgment value, and sets the control start judgment value based on a negative pressure supplied to the brake servo means.

The braking apparatus according to claim 4 includes a negative pressure detecting means that detects a negative pressure supplied to the brake servo means, wherein the controlling means has a judgment value setting means that sets the control start judgment value on a side on which the negative pressure detected by the negative pressure detecting means is small to a value smaller than the control start judgment value on a side on which the negative pressure is large.

In the braking apparatus according to claim 5, the negative pressure is supplied from an intake passage of an internal combustion engine to the brake servo means, the controlling means has a judgment value setting means that estimates a negative pressure supplied to the brake servo means based on a rotational speed of the internal combustion engine, and sets the control start judgment value on a side on which the negative pressure is small to a value smaller than the control start judgment value on a side on which the negative value is large.

In order to achieve the above mentioned object, a braking apparatus according to claim 6 includes a braking means that increases operating force to a brake operating member by a brake servo means by using a negative pressure supplied from an intake passage of an internal combustion engine, generates braking force exerted on wheels corresponding to the increased operating force, and is capable of holding the braking force when a vehicle stops; and a controlling means that executes braking force holding control to hold the braking force when an operation amount of the brake operating member corresponding to the operating force becomes larger than a control start judgment value, and sets the control start judgment value based on a rotational speed of the internal combustion engine.

In the braking apparatus according to claim 7, the controlling means sets a value obtained by adding a set amount to the operation amount when the vehicle on which the braking means is mounted stops as the control start judgment value, and changes the control start judgment value by changing the set amount.

In the braking apparatus according to claim 8, the braking means has an operating pressure applying means that applies an operating pressure to operating fluid corresponding to the operating force, a braking force generating means that generates the braking force by action of a braking pressure based on the operating pressure, a holding means capable of holding the braking pressure, and a pressure-decreasing means capable of decreasing the braking pressure held by the holding means, wherein the controlling means executes the braking force holding control based on the operating pressure being an operation amount of the brake operating member corresponding to the operating force.

### EFFECT OF THE INVENTION

Since the braking apparatus according to the present invention is provided with the controlling means that executes the braking force holding control to hold the braking force when the operation amount of the brake operating member corresponding to the operating force becomes larger than the control start judgment value, and sets the control start judgment value to be smaller than the control start judgment value in the normal state of the brake servo means when the brake servo means fails, even when the increase in the operating force by the brake servo means becomes smaller when the brake servo means fails and the operation amount of the brake operating member corresponding to the operating force decreases, the controlling means sets the control start judgment value to be smaller than the control start judgment value in the normal state of the brake servo means, so that the braking force can be appropriately held.

Also, since the braking apparatus according to the present invention is provided with the controlling means that executes the braking force holding control to hold the braking force when the operation amount of the brake operating member corresponding to the operating force becomes larger than the control start judgment value, and sets the control start judgment value based on the negative pressure supplied to the brake servo means, even when the increase in the operating force by the brake servo means becomes smaller due to the deficiency of the negative pressure supplied to the brake servo means and the operation amount of the brake operating member corresponding to the operating force decreases, the controlling means sets the control start judgment value based on the negative pressure, so that the braking force can be appropriately held.

Also, since the braking apparatus according to the present invention is provided with the controlling means that executes the braking force holding control to hold the braking force when the operation amount of the brake operating member corresponding to the operating force becomes larger than the control start judgment value, and sets the control start judgment value based on the rotational speed of the internal combustion engine, even when the increase in the operating force by the brake servo means becomes smaller due to the deficiency of the negative pressure supplied to the brake servo means and the operation amount of the brake operating member corresponding to the operating force decreases, the controlling means sets the control state judgment value based on the rotational speed of the internal combustion engine, so that the braking force can be appropriately held.

### BRIEF DESCRIPTION OF THE DRAWINGS

FIG. 1 is a schematic configuration diagram of a braking apparatus according to an embodiment of the present invention.

FIG. 2 is a block diagram illustrating an ECU of the braking apparatus according to the embodiment of the present invention.

FIG. 3 is a schematic configuration diagram illustrating a vehicle to which the braking apparatus according to the embodiment of the present invention is applied.

FIG. 4 is a time chart explaining hill start aid control in the braking apparatus according to the embodiment of the present invention.

FIG. 5 is a flow chart explaining the hill start aid control in the braking apparatus according to the embodiment of the present invention.

FIG. 6 is a block diagram illustrating the ECU of the braking apparatus according to a modified example of the present invention.

FIG. 7 is a block diagram illustrating the ECU of the braking apparatus according to the modified example of the present invention.

FIG. 8 is a diagram illustrating relationship between an engine rotational speed and an engine negative pressure in the braking apparatus according to the modified example of the present invention.

### EXPLANATION OF LETTERS OR NUMERALS

1, 1A, 1B Braking apparatus
2 Hydraulic braking apparatus (braking means)
3 ECU (controlling means)
21 Brake pedal (brake operating member)
22 Master cylinder (operating pressure applying means)
23 Reservoir
24 Brake booster (brake servo means)
25 Brake actuator
26FL, 26FR, 26RL, 26RR Wheel cylinder
27FL, 27FR, 27RL, 27RR Hydraulic brake unit (braking force generating means)
34 Braking force holding controller
35 Master cut solenoid valve controller
36 Holding solenoid valve controller
37 Pressure-decreasing solenoid valve controller
38 Pump drive controller
39 Brake booster fail detecting unit (fail detecting means)
40, 40A, 40B Control start judgment value setting unit (judgment value setting means)
55 Brake pedal sensor (operating force detecting means)
58 Master cylinder pressure sensor (operation amount detecting means)
59A Negative pressure sensor (negative pressure detecting means)
59B Engine rotational number sensor
100 Vehicle
101 Engine (internal combustion engine)
108, 111 Wheel
252A, 252B Master cut solenoid valve (holding means, pressure-decreasing means)
253FL, 253FR, 253RL, 253RR Holding solenoid valve
254FL, 254FR, 254RL, 254RR Pressure-decreasing solenoid valve

### BEST MODE(S) FOR CARRYING OUT THE INVENTION

Hereinafter, an embodiment of a braking apparatus according to the present invention is described in detail with reference to the drawings. Meanwhile, the present invention is not limited by the embodiment. Also, components in a following embodiment include a component easily replaced by one skilled in the art or a substantially identical component.

### Embodiment

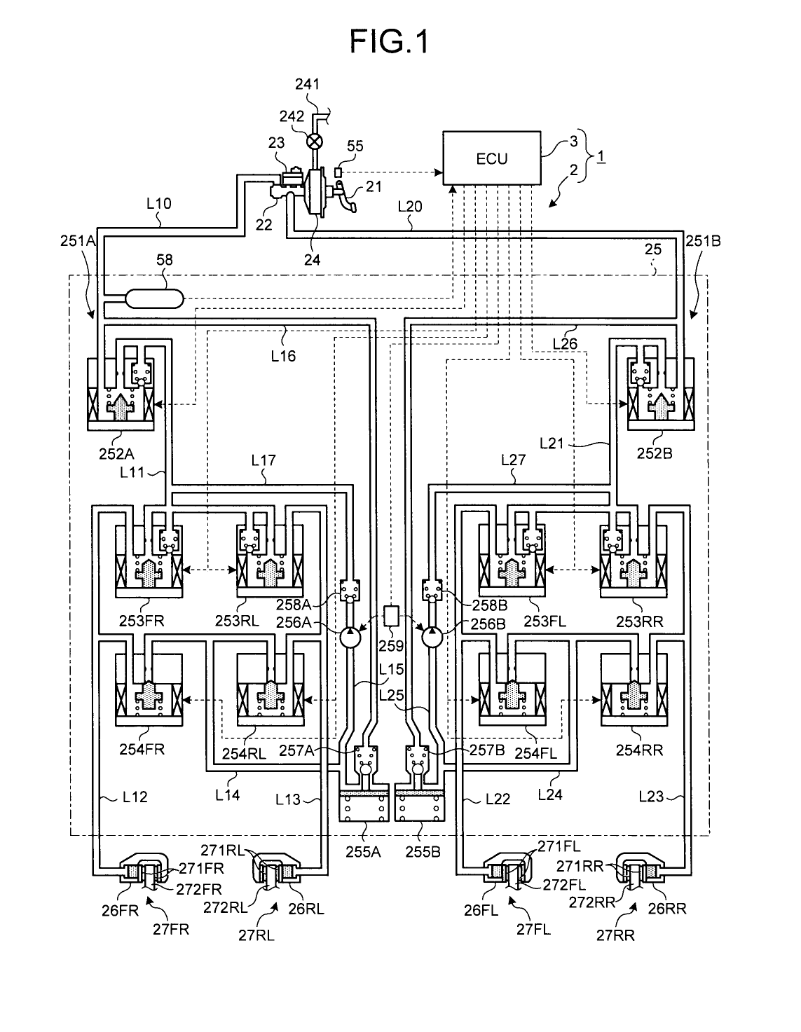

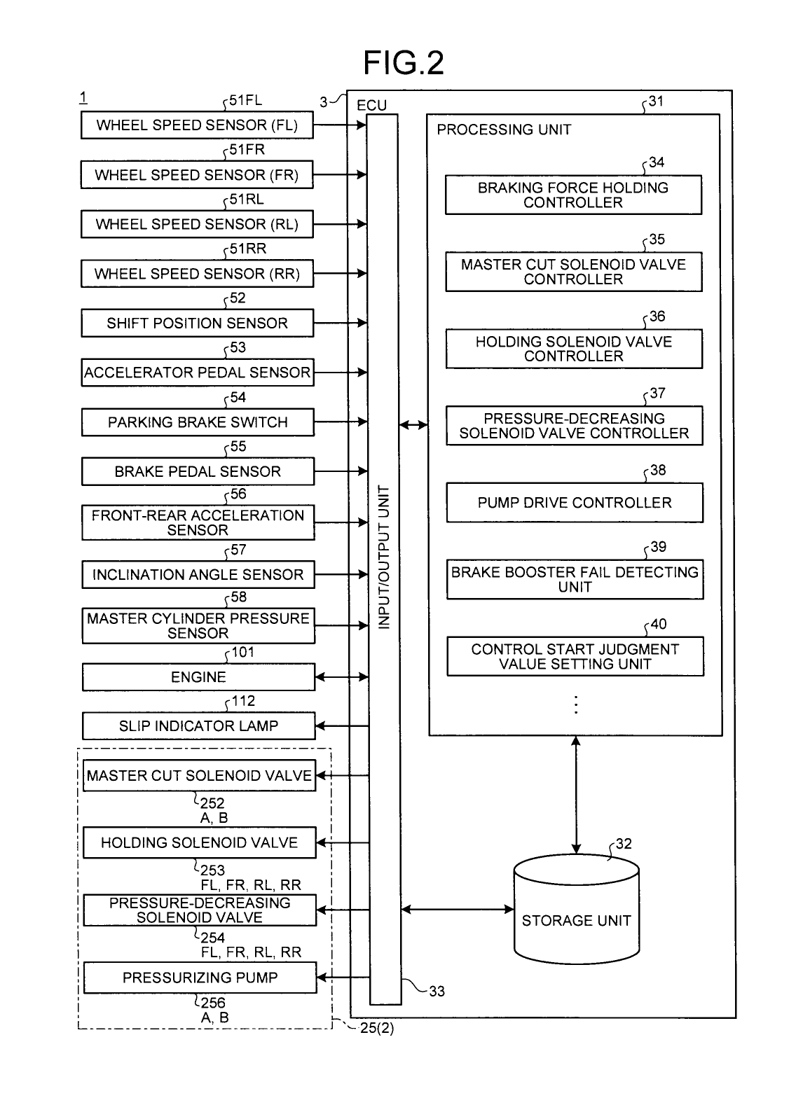

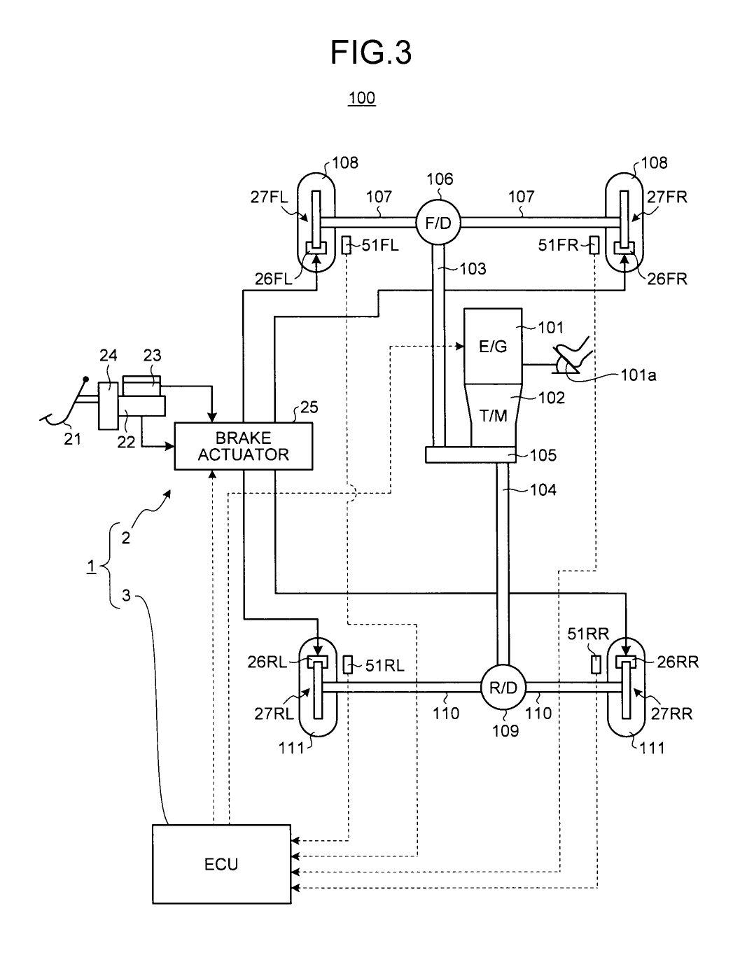

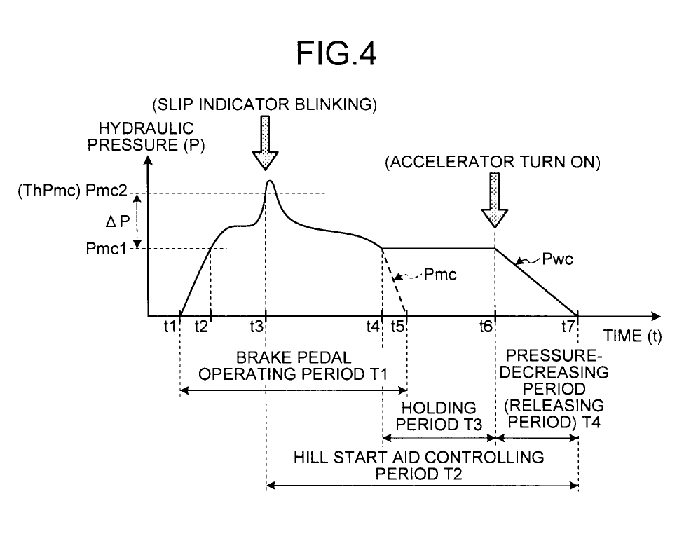

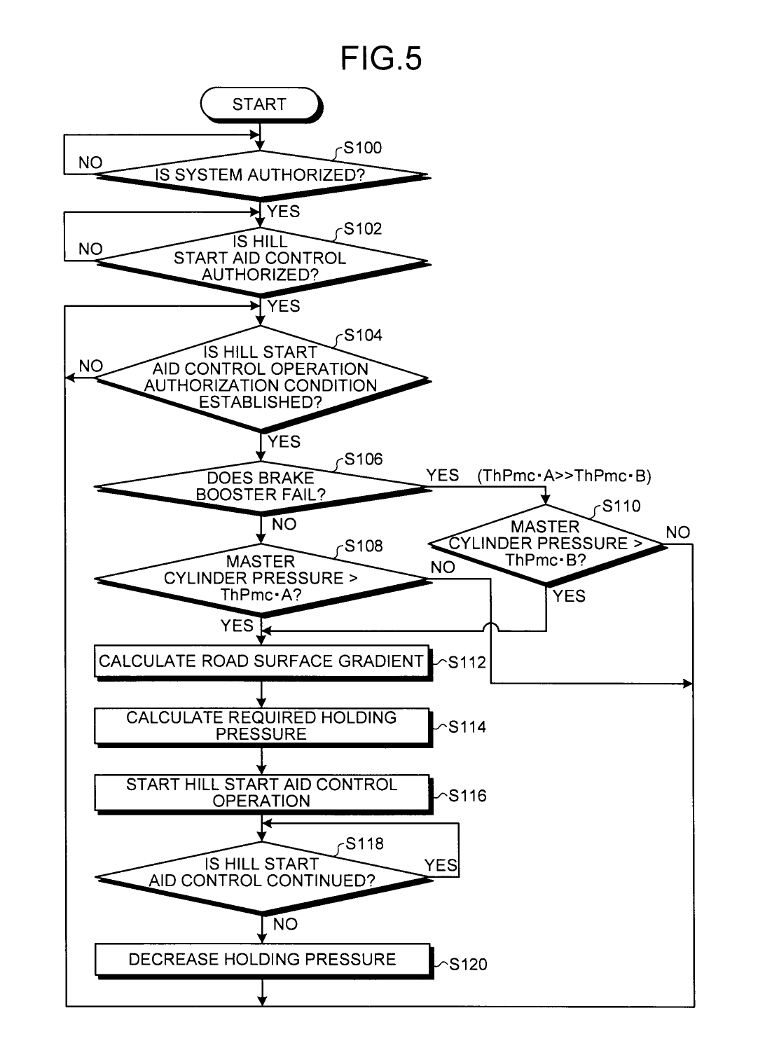

FIG. 1 is a schematic configuration diagram of the braking apparatus according to the embodiment of the present invention, FIG. 2 is a block diagram illustrating an ECU of the braking apparatus according to the embodiment of the present invention, FIG. 3 is a schematic configuration diagram illustrating a vehicle to which the braking apparatus according to the embodiment of the present invention is applied, FIG. 4 is a time chart explaining hill start aid control in the braking apparatus according to the embodiment of the present invention and FIG. 5 is a flowchart explaining the hill start aid control in the braking apparatus according to the embodiment of the present invention.

As illustrated in FIGS. 1 to 3, a braking apparatus 1 according to this embodiment is mounted on a vehicle 100 such as a passenger vehicle and a truck in which a hydraulic braking apparatus 2 composed of brake pads 271FL and 271FR and brake rotors 272FL and 272FR provided on each of wheels 108 of the vehicle 100 and brake pads 271RL and 271RR and brake rotors 272RL and 272RR provided on each of wheels 111 of the vehicle 100 and the like generates braking force (braking torque) exerted on each of the wheels 108 and 111 of the vehicle 100 corresponding to brake operation of a driver. That is to say, in the braking apparatus 1, the hydraulic braking apparatus 2 generates pressure braking force.

Meanwhile, although an internal combustion engine (such as a gasoline engine, a diesel engine and an LPG engine) for generating engine torque is used as a driving source for generating driving force transmitted to the wheels 108 and 111 of the vehicle 100 to which the braking apparatus 1 of this embodiment is applied in the embodiment to be described hereinafter, the driving source is not limited thereto and an electric motor such as a motor for generating motor torque may be used as the driving source. Also, the internal combustion engine and the electric motor may be used together as the driving source.

The braking apparatus 1 is composed of the hydraulic braking apparatus 2 as a braking means and an ECU 3 as a controlling means, and is mounted on the vehicle 100. In the braking apparatus 1 of this embodiment, the hydraulic braking apparatus 2 generates the braking force corresponding to operation of a brake pedal 21 as a brake operating member exerted on the wheels 108 and 111 of the vehicle 100 in which an engine 101 as the driving source generates the driving force corresponding to operation of an accelerator pedal 101a as a drive operating member and the ECU 3 controls the hydraulic braking apparatus 2, so that the braking apparatus 1 is capable of executing braking force holding control to hold the braking force when the vehicle 100 stops and thereafter release holding of the braking force, a so-called hill start aid control. The braking apparatus 1 can prevent reverse movement of the vehicle 100 to smoothly start the vehicle when the vehicle 100 is started on a hill by executing the hill start aid control, for example.

Herein, the vehicle 100 to which the braking apparatus 1 is applied is provided with the engine 101 as the drive source, a transmission 102, a driving shaft 103, a driving shaft 104, a transfer (sub transmission) 105, a front differential 106, front wheel driving shafts 107, the wheels (front wheels) 108, a rear differential 109, rear wheel driving shafts 110 and the wheels (rear wheels) 111 as illustrated in FIG. 3. Meanwhile, although the vehicle 100 illustrated in the drawing illustrates a four-wheel-drive vehicle, the vehicle is not limited to this.

As described above, the engine 101 is mounted on the vehicle 100 to generate the driving force exerted on each of the wheels 108 and 111 of the vehicle 100 corresponding to the operation of the accelerator pedal 101a as the drive operating member. The engine 101 generates the engine torque and of which operation is controlled by the ECU 3. The engine 101 is, for example, the gasoline engine having a plurality of cylinders. In the engine 101, air is sucked through an intake route (intake passage) and fuel injected from a fuel injection valve is supplied to a combustion chamber of each of the cylinder. In the engine 101, when ignition by an ignition plug is performed to air-fuel mixture of the fuel and the air, the air-fuel mixture burns and a piston reciprocates, and a crankshaft, which is an output shaft of the engine 101, rotates. Then, in the engine 101, exhaust air generated by burning of the air-fuel mixture is exhausted from each combustion chamber to an exhaust passage.

The transmission 102 is provided on an output side of the engine 101 to change speed of a rotational output of the engine 101. As the transmission 102, various transmissions such as a manual transmission, an automatic transmission and a continuously variable transmission can be used.

The driving shaft 103 transmits the driving force to a side of the wheels on a front side (front wheels) 108, and the driving shaft 104 transmits the driving force to a side of the wheels on a rear side (rear wheels) 111.

The transfer 105 is provided on an output side of the transmission 102 for distributing the driving force transmitted from the transmission 102 to the driving shaft 103 on the front wheel side and the driving shaft 104 on the rear wheel side. The transfer 105 is provided with two gear trains, which are a high gear train on a high speed side for transmitting the rotational output of the transmission 102 to the driving shafts 103 and 104 without reducing the speed thereof and a low gear train on a low speed side for transmitting the rotational output of the transmission 102 to the driving shafts 103 and 104 by further reducing the speed thereof, and is configured to be able to selectively shift the high gear train and the low gear train to use by operation of a shift lever for the transfer 105 (not illustrated). Also, the transfer 105 is provided with a differential device (center differential) not illustrated inside thereof and is configured to be able to absorb rotational difference between the wheels 108 and 111 generated when the vehicle 100 swings.

The driving shaft 103 on the front wheel side is coupled to the right and left front wheel driving shafts 107 through the front differential 106, and the wheels 108, which are the right and left front wheels, are coupled to the front wheel driving shafts 107. Also, the driving shaft 104 on the rear wheel side is coupled to the right and left rear wheel driving shafts 110 through the rear differential 109, and the wheels 111, which are the right and left rear wheels, are coupled to the rear wheel driving shafts 110. The vehicle 100 is configured such that output torque of the engine 101 is transmitted to each of the wheels 108 and 111 through a power transmission system configured as described above.

Hydraulic brake units 27FL and 27FR and hydraulic brake units 27RL and 27RR as a braking force generating means of the braking apparatus 1 are provided on each of the wheels 108 and 111, respectively. Also, a liquid pressure system of operating liquid for connecting a master cylinder 22 composing the braking apparatus 1 and wheel cylinders 26FL, 26FR, 26RL and 26RR is provided with a brake actuator 25 for increasing and decreasing a liquid pressure in the wheel cylinders 26FL, 26FR, 26RL and 26RR to control the braking force applied to each of the wheels 108 and 111, in addition to operation of the brake pedal 21 as the brake operating member (brake operation) by the driver.

The braking apparatus 1 is composed of the hydraulic braking apparatus 2 as the braking means and the ECU 3 as the controlling means, as illustrated in FIG. 1.

The hydraulic braking apparatus 2 composes a so-called in-line system for generating the pressure braking force. The hydraulic braking apparatus 2 is provided with the brake pedal 21 as the brake operating member, the master cylinder 22 as an operating pressure applying means, a reservoir 23, a brake booster 24 as a brake servo means, the brake actuator 25 as a pressurizing means, the wheel cylinders 26FL, 26FR, 26RL and 26RR and the hydraulic brake units 27FL, 27FR, 27RL and 27RR as the braking force generating means.

Herein, in the hydraulic braking apparatus 2, brake oil, which is operating fluid, is filled in a hydraulic route from the master cylinder 22 through the brake actuator 25 to each of the wheel cylinders 26FL, 26FR, 26RL and 26RR. In the hydraulic braking apparatus 2, basically, an operating pressure is applied to the brake oil by the master cylinder 22 corresponding to pedal force as operating force acting on the brake pedal 21 by operation of the brake pedal 21 by the driver, and the operating pressure, that is to say, a master cylinder pressure Pmc acts on each of the wheel cylinders 26FL, 26FR, 26RL and 26RR as a wheel cylinder pressure Pwc as the braking pressure, and by this, the master pressure braking force is generated as the pressure braking force.

Specifically, the brake pedal 21 is the brake operating member, which is brake-operated by the driver, and is operated when the driver generates the braking force exerted on the vehicle 100, that is to say, by braking request. The brake pedal 21 is, for example, a part with which the driver driving the vehicle 100 inputs the pedal force by his foot as the brake operation. The brake pedal 21 has a tread part and is provided so as to be rotatable around a rotational axis when the pedal force is input on the tread part.

The master cylinder 22 is the operating pressure applying means and is driven corresponding to depression operation of the brake pedal 21 by the driver. The master cylinder 22 pressurizes the brake oil, which is the operating fluid, when the pedal force is input to the brake pedal 21, thereby applying the master cylinder pressure Pmc as the operating pressure thereto. The master cylinder 22 pressurizes the brake oil by a piston not illustrated to which the pedal force acting on the brake pedal 21 by the depression of the brake pedal 21 by the driver is applied. That is to say, in the master cylinder 22, the piston is movable by the pedal force transmitted by the operation of the driver through the brake pedal 21, and the master cylinder pressure Pmc, which is braking hydraulic pressure corresponding to the pedal force, can be output by the movement of the piston. In the master cylinder 22, two hydraulic chambers inside thereof are filled with the brake oil used as the operating fluid, and the pedal force input through the brake pedal 21 is converted to the master cylinder pressure Pmc, which is the liquid pressure (hydraulic pressure) of the brake fluid, corresponding to the brake operation of the brake pedal 21 by the hydraulic chambers and the piston.

The reservoir 23 is coupled to the master cylinder 22, and the brake oil is reserved inside thereof.

The brake booster 24 is a vacuum servo device for doubling (increasing) the pedal force acting on the brake pedal 21 by the depression of the brake pedal 21 by the driver at a predetermined servo ratio by a negative pressure generated by the engine 101 (refer to FIG. 3) to transmit to the piston of the master cylinder 22. The brake booster 24 is integrally mounted on the master cylinder 22 and is connected to the intake route (intake passage) of the engine 101 through negative pressure piping 241 and a check valve 242. The brake booster 24 amplifies the pedal force by force acting on a diaphragm not illustrated by differential pressure between the negative pressure generated in the intake route of the engine 101 and an outside air pressure.

The brake booster 24 can boost the pedal force input from the brake pedal 21 and transmitted through an operating rod by difference between the negative pressure introduced from the intake route of the engine 101 through the negative pressure piping 241 and an atmospheric pressure to transmit to the master cylinder 22. That is to say, the brake booster 24 can boost the pedal force when the brake pedal 21 is brake-operated by the negative pressure and boost the pedal force input to the master cylinder 22 relative to the pedal force input to the brake pedal 21, thereby reducing the pedal force to the brake pedal 21 by the driver.

Then, the master cylinder 22 increases (amplifies) the pedal force acting on the brake pedal 21 by the brake booster 24 and pressurizes the brake oil corresponding to the increased pedal force to apply the master cylinder pressure Pmc as the operating pressure to the brake oil. That is to say, the brake booster 24 composes a part of the operating pressure applying means, in other words, the master cylinder pressure Pmc as the operating pressure corresponds to the pedal force input to the brake pedal 21 by the driver and the negative pressure of the engine 101 (refer to FIG. 3).

The brake actuator 25 is a pressurizing means that controls the wheel cylinder pressure Pwc acting on each of the wheel cylinders 26FL, 26FR, 26RL and 26RR corresponding to the master cylinder pressure Pmc applied to the brake oil by the master cylinder 22, or allows the wheel cylinder pressure Pwc to act on each of the wheel cylinders 26FL, 26FR, 26RL and 26RR regardless of whether the master cylinder pressure Pmc is applied to the brake oil by the master cylinder 22.

Herein, the master cylinder 22 is provided with the two hydraulic chambers not illustrated inside thereof, as described above, and the above-described master cylinder pressure Pmc is generated in each of the hydraulic chambers. The master cylinder 22 is provided with hydraulic piping L10 and hydraulic piping L20, each of which is connected to each of the hydraulic chambers.

The brake actuator 25 is provided as an operating fluid pressure adjusting unit that transmits the hydraulic pressure (master cylinder pressure Pmc) in the hydraulic piping (first hydraulic piping) L10 and the hydraulic piping (second hydraulic piping) L20 directly or after adjusting the same to each of the wheel cylinders 26FL, 26FR, 26RL and 26RR to be described later corresponding to a control command of the ECU 3.

The brake actuator 25 of this embodiment is provided with a first hydraulic control circuit 251A for the right front wheel and the left rear wheel and a second hydraulic control circuit 251B for the right rear wheel and the left front wheel as circuits for transmitting the hydraulic pressure from the master cylinder 22 to the wheel cylinders 26FL, 26FR, 26RL and 26RR. Herein, the first hydraulic control circuit 251A is connected to the hydraulic piping L10 and the second hydraulic control circuit 251B is connected to the hydraulic piping L20.

The brake actuator 25 is composed of master cut solenoid valves 252A and 252B, holding solenoid valves 253FL, 253FR, 253RL and 253RR, pressure-decreasing solenoid valves 254FL, 254FR, 254RL and 254RR, reservoirs 255A and 255B, pressurizing pumps 256A and 256B, check valves 257A, 257B, 258A and 258B, a driving motor 259, and hydraulic piping L10 to L17 and L20 to L27. Herein, the hydraulic piping L10 to L17 compose the first hydraulic control circuit 251A and the hydraulic piping L20 to L27 compose the second hydraulic control circuit 251B.

Each of the master cut solenoid valves 252A and 252B is a pressure-adjusting means composing the pressurizing means (in other words, a flow amount adjusting means of the brake oil) that adjusts pressurized pressure Pp.

The master cut solenoid valve 252A is provided on the first hydraulic control circuit 251A and is connected to the hydraulic piping L10 and L11. The master cut solenoid valve 252A allows the hydraulic piping L10 and L11 to communicate with each other, releases the communication and adjusts a differential pressure between an upstream side and a downstream side of the master cut solenoid valve 252A at the time of the communication by adjusting the flow amount of the brake oil. That is to say, the master cut solenoid valve 252A adjusts a differential pressure between the pressure of the brake oil pressurized by the pressurizing pump 256A to be described later and the master cylinder pressure Pmc as the pressurized pressure Pp.

The master cut solenoid valve 252B is provided on the second hydraulic control circuit 251B and is connected to the hydraulic piping L20 and L21. The master cut solenoid valve 252B allows the hydraulic piping L20 and L21 to communicate with each other, releases the communication and adjusts a differential pressure between an upstream side and a downstream side of the master cut solenoid valve 252B at the time of the communication by adjusting the flow amount of the brake oil. That is to say, the master cut solenoid valve 252B adjusts a differential pressure between the pressure of the brake oil pressurized by the pressurizing pump 256B to be described later and the master cylinder pressure Pmc as the pressurized pressure Pp.

Also, each of the master cut solenoid valves 252A and 252B is provided with the check valve. The check valve of each of the master cut solenoid valves 252A and 252B only allows flow of the brake oil from a side of the hydraulic piping L10 and L20 to a side of the hydraulic piping L11 and L21.

Then, the master cut solenoid valves 252A and 252B are so-called normal open-type linear solenoid valves, which are in an opened state in a normal state in which current is not supplied, and are electrically connected to the ECU 3. Therefore, in each of the master cut solenoid valves 252A and 252B, the current supplied thereto is controlled based on a command current value from the ECU 3, and opening control for controlling opening is performed. That is to say, the master cut solenoid valves 252A and 252B control valve opening corresponding to the command current value, thereby adjusting the flow amount of the brake oil derived from the master cylinder 22 to adjust the pressurized pressure Pp.

The holding solenoid valves 253FL, 253FR, 253RL and 253RR can hold the wheel cylinder pressure Pwc, which is the braking pressure acting on the wheel cylinders 26FL, 26FR, 26RL and 26RR to be described later.

The holding solenoid valve 253FR is provided on the first hydraulic control circuit 251A and is connected to the hydraulic piping L11 connected to the master cylinder 22 through the master cut solenoid valve 252A and the hydraulic piping L10 and to the hydraulic piping L12 connected to the wheel cylinder 26FR. The holding solenoid valve 253FR allows the hydraulic piping L11 and L12 to communicate with each other and releases the communication. That is to say, the holding solenoid valve 253FR allows the master cylinder 22 and the wheel cylinder 26FR to communicate with each other and releases the communication.

The holding solenoid valve 253RL is provided on the first hydraulic control circuit 251A and is connected to the hydraulic piping L11 connected to the master cylinder 22 through the master cut solenoid valve 252A and the hydraulic piping L10 and to the hydraulic piping L13 connected to the wheel cylinder 26RL. The holding solenoid valve 253RL allows the hydraulic piping L11 and L13 to communicate with each other and releases the communication. That is to say, the holding solenoid valve 253RL allows the master cylinder 22 and the wheel cylinder 26RL to communicate with each other and releases the communication.

The holding solenoid valve 253FL is provided on the second hydraulic control circuit 251B and is connected to the hydraulic piping L21 connected to the master cylinder 22 through the master cut solenoid valve 252B and the hydraulic piping L20 and to the hydraulic piping L22 connected to the wheel cylinder 26FL. The holding solenoid valve 253FL allows the hydraulic piping L21 and L22 to communicate with each other and releases the communication. That is to say, the holding solenoid valve 253FL allows the master cylinder 22 and the wheel cylinder 26FL to communicate with each other and releases the communication.

The holding solenoid valve 253RR is provided on the second hydraulic control circuit 251B and is connected to the hydraulic piping L21 connected to the master cylinder 22 through the master cut solenoid valve 252B and the hydraulic piping L20 and to the hydraulic piping L23 connected to the wheel cylinder 26RR. The holding solenoid valve 253RR allows the hydraulic piping L21 and L23 to communicate with each other and releases the communication. That is to say, the holding solenoid valve 253RR allows the master cylinder 22 and the wheel cylinder 26RR to communicate with each other and releases the communication.

Each of the holding solenoid valves 253FL, 253FR, 253RL and 253RR is a so-called normal open-type solenoid valve, which is in the opened state in the normal state in which the current is not supplied, and is electrically connected to the ECU 3. Therefore, opening/closing of each of the holding solenoid valves 253FL, 253FR, 253RL and 253RR is controlled by on/off control by the ECU 3. That is to say, each of the holding solenoid valves 253FL, 253FR, 253RL and 253RR enters an energizing state when being turned on by the ECU 3, and is fully closed at the time of energization. On the other hand, this enters a non-energizing state when being turned off by the ECU 3 and is fully opened at the time of non-energization.

Also, each of the holding solenoid valves 253FL, 253FR, 253RL and 253RR is provided with the check valve for returning the brake oil to an upstream side of each of the holding solenoid valves 253FL, 253FR, 253RL and 253RR (hydraulic piping L11 and L21 side) when a total pressure acting on each of the wheel cylinders 26FL, 26FR, 26RL and 26RR at the time of the energization, that is to say, the wheel cylinder pressure Pwc is higher than the pressure of the brake oil in the hydraulic piping L11 and L21. The check valve of each of the holding solenoid valves 253FL, 253FR, 253RL and 253RR only allows the flow of the brake oil from a side of each of the wheel cylinders 26FL, 26FR, 26RL and 26RR to a side of each of the master cut solenoid valves 252A and 252B.

The pressure-decreasing solenoid valves 254FL, 254FR, 254RL and 254RR can decreases the wheel cylinder pressure Pwc held in the wheel cylinders 26FL, 26FR, 26RL and 26RR to be described later.

The pressure-decreasing solenoid valve 254FR is provided on the first hydraulic control circuit 251A and is connected to the hydraulic piping L12 connected to the wheel cylinder 26FR and to the hydraulic piping (hydraulic exhaust passage) L14 connected to the reservoir 255A. The pressure-decreasing solenoid valve 254FR allows the hydraulic piping L12 and L14 to communicate with each other and releases the communication. That is to say, the pressure-decreasing solenoid valve 254FR allows the wheel cylinder 26FR and the reservoir 255A to communicate with each other and releases the communication.

The pressure-decreasing solenoid valve 254RL is provided on the first hydraulic control circuit 251A and is connected to the hydraulic piping L13 connected to the wheel cylinder 26RL and to the hydraulic piping L14 connected to the reservoir 255A. The pressure-decreasing solenoid valve 254RL allows the hydraulic piping L13 and L14 to communicate with each other and releases the communication. That is to say, the pressure-decreasing solenoid valve 254RL allows the wheel cylinder 26RL and the reservoir 255A to communicate with each other and releases the communication.

The pressure-decreasing solenoid valve 254FL is provided on the second hydraulic control circuit 251B and is connected to the hydraulic piping L22 connected to the wheel cylinder 26FL and to the hydraulic piping (hydraulic exhaust passage) L24 connected to the reservoir 255B. The pressure-decreasing solenoid valve 254FL allows the hydraulic piping L22 and L24 to communicate with each other and releases the communication. That is to say, the pressure-decreasing solenoid valve 254FL allows the wheel cylinder 26FL and the reservoir 255B to communicate with each other and releases the communication.

The pressure-decreasing solenoid valve 254RR is provided on the second hydraulic control circuit 251B and is connected to the hydraulic piping L23 connected to the wheel cylinder 26RR and to the hydraulic piping L24 connected to the reservoir 255B. The pressure-decreasing solenoid valve 254RR allows the hydraulic piping L23 and L24 to communicate with each other and releases the communication. That is to say, the pressure-decreasing solenoid valve 254RR allows the wheel cylinder 26RR and the reservoir 255B to communicate with each other and releases the communication.

Each of the pressure-decreasing solenoid valves 254FL, 254FR, 254RL and 254RR is a so-called normal close-type solenoid valve, which is in a closed state in the normal state in which the current is not supplied, and is electrically connected to the ECU 3. Therefore, opening/closing of each of the pressure-decreasing solenoid valves 254FL, 254FR, 254RL and 254RR is controlled by the on/off control by the ECU 3. That is to say, each of the pressure-decreasing solenoid valves 254FL, 254FR, 254RL and 254RR enters the energizing state when being turned on by the ECU 3 and is fully opened at the time of the energization. On the other hand, this enters the non-energizing state when being turned off by the ECU 3 and is fully closed at the time of the non-energization.

The reservoir 255A is provided on the first hydraulic control circuit 251A and is connected to the hydraulic piping L14, the hydraulic piping L15 connected to the pressurizing pump 256A and the hydraulic piping (intake passage) L16 communicating with the hydraulic piping L10 through the check valve 257A for reservoir cut. Therefore, the brake oil exhausted from the pressure-decreasing solenoid valves 254FR and 254RL through the hydraulic piping L14 or the brake oil sucked from the hydraulic piping L10, that is to say, the upstream side of the master cut solenoid valve 252A through the hydraulic piping L16 can be introduced into the reservoir 255A.

The reservoir 255B is provided on the second hydraulic control circuit 251B and is connected to the hydraulic piping L24, the hydraulic piping L25 connected to the pressurizing pump 256B and the hydraulic piping (intake passage) L26 communicating with the hydraulic piping L20 through the check valve 257B for reservoir cut. Therefore, the brake oil exhausted from the pressure-decreasing solenoid valves 254FL and 254RR through the hydraulic piping L24 or the brake oil sucked from the hydraulic piping L20, that is to say, the upstream side of the master cut solenoid valve 252B through the hydraulic piping L26 can be introduced into the reservoir 255B.

The pressurizing pump 256A is provided on the first hydraulic control circuit 251A and is connected to the hydraulic piping L15 connected to the reservoir 255A and the hydraulic piping (pump passage) L17 communicating with the hydraulic piping L11 through the check valve 258A. Therefore, the pressurizing pump 256A sucks the brake oil on the upstream side of the master cut solenoid valve 252A through the hydraulic piping L16 and the reservoir 255A and pressurizes the same to discharge to the hydraulic piping L11, that is to say, the downstream side of the master cut solenoid valve 252A.

The pressurizing pump 256B is provided on the second hydraulic control circuit 251B and is connected to the hydraulic piping L25 connected to the reservoir 255B and to the hydraulic piping (pump passage) L27 communicating with the hydraulic piping L21 through the check valve 258B. Therefore, the pressurizing pump 256B sucks the brake oil on the upstream side of the master cut solenoid valve 252B through the hydraulic piping L26 and the reservoir 255B and pressurizes the same to discharge to the hydraulic piping L21, that is to say, the downstream side of the master cut solenoid valve 252B.

Herein, each of the pressurizing pumps 256A and 256B is driven by the driving motor 259. The driving motor 259 is connected to the ECU 3. Therefore, each of the pressurizing pumps 256A and 256B is drive-controlled by the drive-control of the driving motor 259 by the ECU 3.

As described above, the brake actuator 25 as the pressurizing means applies the pressurized pressure Pp to the brake oil, by pressurization of the brake oil by each of the pressurizing pumps 256A and 256B and by adjustment of the differential pressure between the pressure of the pressurized brake oil and the master cylinder pressure by each of the master cut solenoid valves 252A and 252B.

Herein, operation of the brake actuator 25 is described always with reference to FIG. 1.

In a pressure-intensifying mode, the brake actuator 25 is controlled by the ECU 3 such that each of the master cut solenoid valves 252A and 252B is in the non-energizing state, each of the holding solenoid valves 253FL, 253FR, 253RL and 253RR is in the non-energizing state, each of the pressure-decreasing solenoid valves 254FL, 254FR, 254RL and 254RR is in the non-energizing state and each of the pressurizing pumps 256A and 256B is in a non-driven state. That is to say, in the pressure-intensifying mode of the brake actuator 25, the master cylinder 22 and each of the wheel cylinders 26FL, 26FR, 26RL and 26RR are connected through the hydraulic piping L10 and L20, each of the master cut solenoid valves 252A and 252B, the hydraulic piping L11 and L21, each of the holding solenoid valves 253FL, 253FR, 253RL and 253RR and the hydraulic piping L12, L13, L22 and L23. Therefore, the master cylinder pressure Pmc, which is the operating pressure applied to the brake oil by the master cylinder 22, directly acts on each of the wheel cylinders 26FL, 26FR, 26RL and 26RR as the wheel cylinder pressure Pwc. According to this, the wheel cylinder pressure Pwc acting on each of the wheel cylinders 26FL, 26FR, 26RL and 26RR can be controlled corresponding to the master cylinder pressure Pmc. Meanwhile, when the master cylinder pressure Pmc applied to the brake oil by the master cylinder 22 decreases, the wheel cylinder pressure Pwc also decreases. At that time, the brake oil in each of the wheel cylinders 26FL, 26FR, 26RL and 26RR is returned to the master cylinder 22 through the hydraulic piping L12, L13, L22 and L23, each of the holding solenoid valves 253FL, 253FR, 253RL and 253RR, the hydraulic piping L11 and L21, each of the master cut solenoid valves 252A and 252B and the hydraulic piping L10 and L20, and is reserved in the reservoir 23.

Then, the brake actuator 25 can apply the pressurized pressure Pp to the brake oil in the pressure-intensifying mode. In the brake actuator 25, for example, when the opening of the master cut solenoid valves 252A and 252B is controlled based on the command current value from the ECU 3 to be smaller than that of a fully-opened state, and when the driving motor 259 for driving the pressurizing pumps 256A and 256B is drive-controlled based on a drive command value from the ECU 3, the brake oil is introduced from the upstream side of each of the master cut solenoid valves 252A and 252B, that is to say, from the hydraulic piping L10 and L20 through the hydraulic piping L16 and L26 to each of the reservoirs 255A and 255B. The brake oil introduced into each of the reservoirs 255A and 255B is sucked and pressurized by the pressurizing pumps 256A and 256B and is filled in each of the wheel cylinders 26FL, 26FR, 26RL and 26RR through the hydraulic piping L17, L27, L11 and L21, each of the holding solenoid valves 253FL, 253FR, 253RL and 253RR and the hydraulic piping L12, L13, L22 and L23. Herein, each of the master cut solenoid valves 252A and 252B adjusts the differential pressure between the brake oil on the downstream side of each of the master cut solenoid valves 252A and 252B, that is to say, the wheel cylinder pressure Pwc acting on each of the wheel cylinders 26FL, 26FR, 26RL and 26RR, and the brake oil on the upstream side of each of the master cut solenoid valves 252A and 252B, that is to say, the master cylinder pressure Pmc generated by the master cylinder 22 as the pressurized pressure Pp, so that the wheel cylinder pressure Pwc is the total pressure of the master cylinder pressure Pmc and the pressurized pressure Pp. That is to say, the total pressure of the master cylinder pressure Pmc and the pressurized pressure Pp acts on each of the wheel cylinders 26FL, 26FR, 26RL and 26RR as the wheel cylinder pressure Pwc.

In a holding mode, the brake actuator 25 is controlled by the ECU 3 such that the master cut solenoid valves 252A and 252B are in the non-energizing state, each of the holding solenoid valves 253FL, 253FR, 253RL and 253RR is in the energizing state, each of the pressure-decreasing solenoid valves 254FL, 254FR, 254RL and 254RR is in the non-energizing state and each of the pressurizing pumps 256A,256B is in the non-driven state. That is to say, since the brake oil is held between each of the holding solenoid valves 253FL, 253FR, 253RL and 253RR and each of the wheel cylinders 26FL, 26FR, 26RL and 26RR in the holding mode of the brake actuator 25, the wheel cylinder pressure Pwc acting on each of the wheel cylinders 26FL, 26FR, 26RL and 26RR can be maintained constant. Therefore, the liquid pressure of the liquid pressure system from the holding solenoid valves 253FL, 253FR, 253RL and 253RR to the wheel cylinders 26FL, 26FR, 26RL and 26RR side, that is to say, the wheel cylinder pressure Pwc can be held by controlling the holding solenoid valves 253FL, 253FR, 253RL and 253RR to be in the closed-state, and as a result, the braking force applied to each of the wheels 108, 111 can be held.

In a pressure-decreasing mode, the brake actuator 25 is controlled by the ECU 3 such that the master cut solenoid valves 252A and 252B are in the non-energizing state, each of the holding solenoid valves 253FL, 253FR, 253RL and 253RR is in the energizing state, each of the pressure-decreasing solenoid valves 254FL, 254FR, 254RL and 254RR is in the energizing state and each of the pressurizing pumps 256A and 256B is in the non-driven state. That is to say, in the pressure-decreasing mode of the brake actuator 25, the brake oil held between each of the holding solenoid valves 253FL, 253FR, 253RL and 253RR and each of the wheel cylinders 26FL, 26FR, 26RL and 26RR is recovered and reserved in the reservoirs 255A and 255B through the hydraulic piping L14 and L24 and the hydraulic piping L15 and L25, so that the wheel cylinder pressure Pwc acting on each of the wheel cylinders 26FL, 26FR, 26RL and 26RR can be decreased. According to this, for example, the brake actuator 25 can perform anti-lock brake control for inhibiting any of the wheels 108 and 111 from locking and slipping on a road surface.

Meanwhile, the brake actuator 25 can independently, that is to say, separately adjust the wheel cylinder pressure Pwc acting on each of the wheel cylinders 26FL, 26FR, 26RL and 26RR. Also, the brake actuator 25 can pressurize the brake oil by the ECU 3 even when the operation of the brake pedal 21 by the driver is not performed. At that time, by controlling the brake actuator 25 by the ECU 3 so as to realize the above-described holding mode and pressure-decreasing mode, the wheel cylinder pressure Pwc acting on each of the wheel cylinders 26FL, 26FR, 26RL and 26RR can be adjusted. According to this, the brake actuator 25 can perform traction control for inhibiting any of the front and rear wheels from slipping on the road surface while transmitting the driving force on the road surface and vehicle stability control (VSC) for inhibiting any of the front and rear wheels from skidding while the vehicle 100 is swinging.

Next, the hydraulic brake units 27FL, 27FR, 27RL and 27RR are the braking force generating means and are provided with the brake pads 271FL, 271FR, 271RL and 271RR and the brake rotors 272FL, 272FR, 272RL and 272RR in addition to the wheel cylinders 26FL, 26FR, 26RL and 26RR, respectively. The hydraulic brake units 27FL, 27FR, 27RL and 27RR generate the pressure braking force by action of the wheel cylinder pressure Pwc, which is the pressure of the brake oil filled in each of the wheel cylinders 26FL, 26FR, 26RL and 26RR, that is to say, the total pressure of the master cylinder pressure Pmc and the pressurized pressure Pp, as the braking pressure.

Then, in the vehicle 100, the wheel cylinder 26FR, the brake pad 271FR and the brake rotor 272FR are provided on the right front wheel, the wheel cylinder 26RL, the brake pad 271RL and the brake rotor 272RL are provided on the left rear wheel, the wheel cylinder 26FL, the brake pad 271FL and the brake rotor 272FL are provided on the left front wheel, and the wheel cylinder 26RR, the brake pad 271RR and the brake rotor 272RR are provided on the right rear wheel. That is to say, the piping of the hydraulic braking apparatus 2 is arranged in cross piping with respect to each of the wheels 108 and 111 (refer to FIG. 3). Each of the wheel cylinders 26FL, 26FR, 26RL and 26RR allows each of the brake pads 271FL, 271FR, 271RL and 271RR to contact each of the brake rotors 272FL, 272FR, 272RL and 272RR opposed to each of the brake pads 271FL, 271FR, 271RL and 271RR to be integrally rotated with each of the wheels 108 and 111 by action of the wheel cylinder pressure Pwc, thereby generating the pressure braking force by frictional force generated between each of the brake pads 271FL, 271FR, 271RL and 271RR and each of the brake rotors 272FL, 272FR, 272RL and 272RR. Meanwhile, each of the brake pads 271FR and 271FL and the brake rotors 272FR and 272FL provided on the right and left front wheels are set to generate the frictional force larger than the frictional force generated between each of the brake pads 271RL and 271RR and brake rotors 272RL and 272RR provided on the right and left rear wheels when the same wheel cylinder pressure Pwc acts on each of the wheel cylinders 26FL, 26FR, 26RL and 26RR.

Herein, in the braking apparatus 1 of this embodiment, the braking force corresponding to the master cylinder pressure Pmc by the master cylinder 22 is referred to as master pressure braking force, and the braking force corresponding to the differential pressure between the wheel cylinder pressure Pwc, which should act on each of the wheel cylinders 26FL, 26FR, 26RL and 26RR, and the master cylinder pressure Pmc, that is to say, the braking force corresponding to the pressurized pressure Pp by the pressurizing pumps 256A and 256B of the brake actuator 25 is referred to as differential pressure braking force. That is to say, the hydraulic braking apparatus 2 can generate total pressure braking force of the master pressure braking force corresponding to the master cylinder pressure Pmc and the differential braking force corresponding to the pressurized pressure Pp. In other words, the hydraulic braking apparatus 2 can generate total predetermined pressure braking force (wheel pressure braking force) of the master pressure braking force and the differential pressure braking force as the braking force corresponding to the wheel cylinder pressure Pwc as the total pressure of the master cylinder pressure Pmc and the pressurized pressure Pp.

The ECU 3 is composed mainly of a microcomputer for controlling each unit such as the braking apparatus 1 and the brake actuator 25 of the braking apparatus 1 corresponding to an operating state of the vehicle 100 on which the braking apparatus 1 is mounted. Herein, the ECU 3 also controls operation of the engine 101 based on various input signals input from sensors attached to parts of the vehicle 100 on which the engine 101 is mounted and various maps. For example, the ECU 3 determines a fuel injection amount, injection timing and ignition timing based on an engine operating state such as a vehicle speed, intake air mass, throttle opening, an engine rotational number and a cooling water temperature, and performs control of an injector, control of an ignition plug and throttle opening control of a throttle valve of the engine 101.

Herein, as illustrated in FIG. 2, various sensors such as wheel speed sensors 51FL, 51FR, 51RL and 51RR, a shift position sensor 52, an accelerator pedal sensor 53, a parking brake switch 54, a brake pedal sensor 55, a front-rear acceleration sensor 56, an inclination angle sensor 57 and a master cylinder pressure sensor 58 are electrically connected to the ECU 3. Then, the ECU 3 is electrically connected to a fuel injection valve, the throttle valve and the ignition plug of the engine 101, the master cut solenoid valves 252A and 252B, the holding solenoid valves 253FL, 253FR, 253RL and 253RR, the pressure-decreasing solenoid valves 254FL, 254FR, 254RL and 254RR and the pressurizing pumps 256A and 256B of the brake actuator 25. The ECU 3 executes the brake control by executing a brake control program based on an operating state of the braking apparatus 1 detected by the above-described various sensors and the vehicle 100 on which the braking apparatus 1 is mounted, and adjusts the wheel cylinder pressure (braking hydraulic pressure) Pwc to the wheel cylinders 26FL, 26FR, 26RL and 26RR by driving the brake actuator 25 to allow predetermined braking force corresponding to the braking request of the driver to act on the wheels 108 and 111, thereby reducing the speed of the rotation of the wheels 108 and 111.

Each of the wheel speed sensors 51FL, 51FR, 51RL and 51RR detects a rotational speed of each of the wheels 108 and 111. The wheel speed sensors 51FL, 51FR, 51RL and 51RR are connected to the ECU 3, and the rotational speed of each of the wheels 108 and 111 detected by the wheel speed sensors 51FL, 51FR, 51RL and 51RR is output to the ECU 3. The ECU 3 can calculate the vehicle speed of the vehicle 100 based on the rotational speed of each of the wheels 108 and 111 detected by the wheel speed sensors 51FL, 51FR, 51RL and 51RR.

The shift position sensor 52 detects a shift position (for example, a parking position, a reverse position, a neutral position and a drive position) of the vehicle 100 on which the braking apparatus 1 is mounted. The shift position sensor 52 is connected to the ECU 3 and the shift position detected by the shift position sensor 52 is output to the ECU 3.

The accelerator pedal sensor 53 detects the operation of the accelerator pedal 101a (refer to FIG. 3) by the driver, that is to say, accelerator operation. Herein, the accelerator pedal sensor 53 detects operation and non-operation of the accelerator pedal 101a, that is to say, turning on and turning off of the accelerator, and detects an operation amount of the accelerator pedal 101a by the driver, that is to say, an accelerator depression amount (accelerator opening). The accelerator pedal sensor 53 is connected to the ECU 3 and the turning on and turning off of the accelerator and the accelerator depression amount detected by the accelerator pedal sensor 53 are output to the ECU 3. Meanwhile, an accelerator switch for detecting the turning on and the turning off of the accelerator may be connected to the ECU 3, separate from the accelerator pedal sensor 53.

The parking brake switch 54 detects operation and non-operation, that is to say, turning on and turning off of the parking brake of the vehicle 100 on which the braking apparatus 1 is mounted. The parking brake switch 54 is connected to the ECU 3 and a detection result of the turning on and turning off of the parking brake detected by the parking brake switch 54 is output to the ECU 3.

The brake pedal sensor 55 detects the operation of the brake pedal 21 by the driver, that is to say, the brake operation. Herein, the brake pedal sensor 55 detects operation and non-operation of the brake pedal 21, that is to say, turning on and turning off of the brake, and detects a brake depression amount (pedal stroke) of the brake pedal 21 by the driver. Further, the brake pedal sensor 55 also detects the pedal force as the operating force input to the brake pedal 21 by the driver. That is to say, the brake pedal sensor 55 corresponds to operating force detecting means of the present invention that detects the pedal force input to the brake pedal 21. The brake pedal sensor 55 is connected to the ECU 3 and the turning on and turning off of the brake, the pedal stroke and the pedal force detected by the brake pedal sensor 55 are output to the ECU 3. Meanwhile, the brake pedal sensor 55 may be provided with a brake switch for detecting the turning on and turning off of the brake, a pedal stroke sensor for detecting the pedal stroke and a pedal force sensor for detecting the pedal force separately.

The front-rear acceleration sensor 56 detects acceleration in a front-rear direction of the vehicle 100 on which the braking apparatus 1 is mounted. The front-rear acceleration sensor 56 is connected to the ECU 3 and the acceleration in the front-rear direction of the vehicle 100 detected by the front-rear acceleration sensor 56 is output to the ECU 3.

The inclination angle sensor 57 detects an angle of inclination of the road surface on which the vehicle 100 on which the braking apparatus 1 is mounted is located, that is to say, a road surface gradient. The inclination angle sensor 57 is connected to the ECU 3 and the road surface gradient detected by the inclination angle sensor 57 is output to the ECU 3. Meanwhile, the braking apparatus 1 may obtain road surface gradient information (map information), which is information indicating the road surface gradient, by using a navigation system and a global positioning system (GPS) receiver, for example, in place of the inclination angle sensor 57, to detect the road surface gradient of the road surface on which the vehicle 100 is located based on the road surface gradient information. That is to say, means for detecting the road surface gradient may be composed of means for obtaining the road surface gradient information of the road surface gradient when the vehicle 100 stops.

The master cylinder pressure sensor 58 detects the operating pressure, that is to say, the master cylinder pressure Pmc. The master cylinder pressure sensor 58 is provided in the middle of the hydraulic piping L10, which connects the master cylinder 22 and the master cut solenoid valve 252A of the brake actuator 25. That is to say, the master cylinder pressure sensor 58 detects the pressure of the brake oil in the hydraulic piping L10 as the operating pressure, that is to say, the master cylinder pressure Pmc. The master cylinder pressure sensor 58 is connected to the ECU 3 and the master cylinder pressure Pmc detected by the master cylinder pressure sensor 58 is output to the ECU 3. Meanwhile, as described above, the master cylinder 22 generates the master cylinder pressure Pmc corresponding to the brake operation of the brake pedal 21, that is to say, the master cylinder pressure Pmc detected by the master cylinder pressure sensor 58 corresponds to an operation amount of the brake pedal 21 by the driver. That is to say, the master cylinder pressure sensor 58 corresponds to an operation amount detecting means of the present invention that detects the master cylinder pressure Pmc as the operation amount of the brake pedal 21 corresponding to the pedal force.

In the braking apparatus 1 configured as above, when the driver operates the brake pedal 21 and the pedal force is input to the brake pedal 21, the pedal force is transmitted to the brake booster 24 through the operating rod. Then, the pedal force transmitted to the brake booster 24 is doubled at the predetermined servo ratio by the brake booster 24 to be transmitted to the master cylinder 22. The pedal force doubled by the brake booster 24 and is transmitted to the master cylinder 22 is converted to the master cylinder pressure Pmc by the master cylinder 22 and is transmitted to the wheel cylinders 26FL, 26FR, 26RL and 26RR through the brake actuator 25. At that time, the wheel cylinder pressure Pwc, which is the braking hydraulic pressure supplied to the wheel cylinders 26FL, 26FR, 26RL and 26RR, is adjusted to a predetermined hydraulic pressure by the brake actuator 25 and is transmitted to the wheel cylinders 26FL, 26FR, 26RL and 26RR. Then, in the wheel cylinders 26FL, 26FR, 26RL and 26RR, the brake pads 271FL, 271FR, 271RL and 271RR and the brake rotors 272FL, 272FR, 272RL and 272RR composing the hydraulic brake units 27FL, 27FR, 27RL and 27RR, respectively, a predetermined wheel cylinder pressure Pwc acts on each of the wheel cylinders 26FL, 26FR, 26RL and 26RR, and the brake pads 271FL, 271FR, 271RL and 271RR are pressed against the brake rotors 272FL, 272FR, 272RL and 272RR, and the pressure braking force (pressure braking torque) acts by frictional force by this, thereby reducing the speed of the rotation of the brake rotors 272FL, 272FR, 272RL and 272RR. As a result, the speed of the brake rotors 272FL, 272FR, 272RL and 272RR is reduced, and by this, the speed of the rotation of the wheels can be reduced.

In the meantime, the ECU 3 controls the master cut solenoid valves 252A and 252B, the holding solenoid valves 253FL, 253FR, 253RL and 253RR, the pressure-decreasing solenoid valves 254FL, 254FR, 254RL and 254RR and the pressurizing pumps 256A and 256B of the brake actuator 25, thereby adjusting the pressurized pressure Pp to adjust the wheel cylinder pressure (braking hydraulic pressure) Pwc to the wheel cylinders 26FL, 26FR, 26RL and 26RR to allow the predetermined pressure braking force to act on the wheels 108 and 111, thereby reducing the speed of the rotation of the wheels.

The ECU 3 calculates a target braking force, which is a target braking force corresponding to the brake operation of the brake pedal 21 by the driver (braking request) based on the pedal stroke (brake depression amount) of the brake pedal 21 and the master cylinder pressure Pmc of the master cylinder 22 obtained by this, for example, and controls the brake actuator 25 based on the target braking force, thereby operating the hydraulic brake units 27FL, 27FR, 27RL and 27RR to generate the predetermined braking force so as to realize the target braking force.

Then, as described above, the ECU 3 controls the hydraulic braking apparatus 2, thereby executing the braking force holding control to hold the braking force when the vehicle 100 stops on the hill and the like and thereafter release the holding of the braking force, the so-called hill start aid control.

The ECU 3 controls the master cut solenoid valves 252A and 252B of the brake actuator 25 to be in the closed state based on a predetermined braking force holding control command when the vehicle 100 stops on the hill and the like, thereby holding the wheel cylinder pressure Pwc from the master cut solenoid valves 252A and 252B to the wheel cylinders 26FL, 26FR, 26RL and 26RR side as a predetermined holding pressure. Then, by holding the wheel cylinder pressure Pwc from the master cut solenoid valves 252A and 252B to the wheel cylinders 26FL, 26FR, 26RL and 26RR side as the predetermined holding pressure, the braking force applied to each of the wheels 108 and 111 can be held.

Herein, the predetermined braking force holding control command is generated when the vehicle 100 is in a stopped state, that is to say, when the vehicle speed of the vehicle 100 detected by the wheel speed sensors 51FL, 51FR, 51RL and 51RR is 0 km/h, the turning off of the parking brake is detected by the parking brake switch 54, turning off of the accelerator operation, that is to say, the turning off of the accelerator is detected by the accelerator pedal sensor 53, and predetermined brake operation by the driver is detected, for example, and the ECU 3 starts the braking force holding control to hold the wheel cylinder pressure Pwc as the holding pressure based on the braking force holding control command. As the predetermined brake operation by the driver, there are various brake operations, which can be distinguished from normal brake operation as starting request of the braking force holding control by the driver, such as the brake operation in which the brake pedal 21 is depressed by the driver beyond a predetermined amount, and the brake operation in which the brake pedal 21 is depressed by the driver to stop the vehicle 100 and thereafter the brake pedal 21 is further depressed from this state beyond a predetermined set amount, for example. By this, the ECU 3 can start the braking force holding control (hill start aid control) corresponding to the request of the driver.

Then, the ECU 3 controls the master cut solenoid valves 252A and 252B of the brake actuator 25 to be in the opened state based on a predetermined braking force hold releasing control command, thereby decreasing the wheel cylinder pressure Pwc as the holding pressure from the master cut solenoid valves 252A and 252B to the wheel cylinders 26FL, 26FR, 26RL and 26RR side. Then, by decreasing the wheel cylinder pressure Pwc from the master cut solenoid valves 252A and 252B to the wheel cylinders 26FL, 26FR, 26RL and 26RR side, holding of the braking force applied to each of the wheels 108 and 111 can be released. Meanwhile, when decreasing the wheel cylinder pressure Pwc by the master cut solenoid valves 252A and 252B, the brake oil is returned to the reservoir 23.

Herein, the predetermined braking force hold releasing control command is generated, for example, when a predetermined time (for example, 2 seconds) has passed after turning off of the brake operation, that is to say, the turning off of the brake is detected by the brake pedal sensor 55, when the turning on of the parking brake is detected by the parking brake switch 54, when the turning on of the accelerator is detected by the accelerator pedal sensor 53, or when further depression of the brake pedal 21 by the driver is detected by the brake pedal sensor 55, and the ECU 3 starts the braking force hold releasing control to decrease the wheel cylinder pressure Pwc as the holding pressure based on the braking force hold releasing control command.

Meanwhile, in the braking force holding control (hill start aid control), the master cut solenoid valves 252A and 252B serve as a holding means of the present invention capable of holding the braking pressure and also serve as a pressure-decreasing means of the present invention capable of decreasing the braking pressure held by the holding means. That is to say, in the braking apparatus 1 of this embodiment, the master cut solenoid valves 252A and 252B double as the holding means of the present invention capable of holding the braking pressure and the pressure-decreasing means of the present invention capable of decreasing the braking pressure held by the holding means.

FIG. 4 is a time chart illustrating an example of the hill start aid control (braking force holding control) in the braking apparatus 1 according to the embodiment of the present invention. FIG. 4 illustrates the wheel cylinder pressure Pwc and the master cylinder pressure Pmc by a solid line and a dotted line, respectively, in which the time and the hydraulic pressure are represented along a horizontal axis and a vertical axis, respectively. Herein, a case in which the pressurized pressure Pp is not added by the brake actuator 25, that is to say, a case in which the master cylinder pressure Pmc directly acts as the wheel cylinder pressure Pwc is illustrated. That is to say, until a time t4 at which the wheel cylinder pressure Pwc is actually held as the predetermined holding pressure, the master cylinder pressure Pmc and the wheel cylinder pressure Pwc are identical to each other.

First, when the driver depresses the brake pedal 21 at a time t1 to allow the braking force required by the driver to act on the wheels 108 and 111 of the vehicle 100, the vehicle 100 stops at a time t2 by the braking force. At that time, both of the parking brake and the accelerator operation are turned off. When the driver further depresses the brake pedal 21 from this state and a master cylinder pressure Pmc2 (value corresponding to the operation amount of the brake pedal 21 by the driver) detected by the master cylinder pressure sensor 58 at a time t3 increases to a control start judgment hydraulic pressure ThPmc as a control start judgment value obtained by adding a set hydraulic pressure ΔP as a predetermined set amount to a master cylinder pressure (vehicle stopping time hydraulic pressure) Pmc1 when the vehicle stops at the time t2, the ECU 3 generates the braking force holding control command to start the braking force holding control as the hill start aid control. That is to say, by return of the brake pedal 21 by the driver, the wheel cylinder pressure Pwc as well as the master cylinder pressure Pmc decreases, and when the wheel cylinder pressure Pwc becomes the predetermined holding pressure corresponding to the braking force with which the vehicle 100 does not slide down the hill at the time t4, the ECU 3 controls the master cut solenoid valves 252A and 252B of the brake actuator 25 to be in the closed state, thereby starting to hold the wheel cylinder pressure Pwc as the predetermined holding pressure. At that time, the master cylinder pressure Pmc directly decreases to be approximately 0 at a time period t5 in association with the return of the brake pedal 21 and the turning off of the brake operation.

Meanwhile, when the master cylinder pressure Pmc increases to the control start judgment hydraulic pressure ThPmc at the time t3 and the ECU 3 generates the braking force holding control command to start the braking force holding control as the hill start aid control, this may notify the driver of the start of the hill start aid control by blinking a slip indicator lamp 112 (refer to FIG. 2), for example.

When the driver depresses the accelerator pedal 101a (refer to FIG. 3) at a time t6 to allow the driving force required by the driver to act on the wheels 108 and 111 of the vehicle 100, for example, the turning on of the accelerator is detected by the accelerator pedal sensor 53, and the ECU 3 generates the braking force hold releasing control command to start the braking force hold releasing control. That is to say, the ECU 3 controls the master cut solenoid valves 252A and 252B of the brake actuator 25 to be in the opened state, thereby starting to decrease the wheel cylinder pressure Pwc held as the holding pressure, and by this, the wheel cylinder pressure Pwc gradually decreases to be approximately 0 at a time t7. As a result, for example, the sliding down of the vehicle 100 when starting the vehicle 100 on the hill is prevented, and the driver can smoothly start the vehicle 100.

Meanwhile, as illustrated in the drawing, a brake pedal operating period T1 in which the brake pedal 21 is actually depressed by the driver and the brake is turned on is a period from the time t1 to the time t5. On the other hand, a hill start aid controlling period T2 in which the hill start aid control is executed is a period from the time t3 to the time t7, and more specifically, a holding period T3 in which the wheel cylinder pressure Pwc is actually held as the predetermined holding pressure by the master cut solenoid valves 252A and 252B is a period from the time t4 to the time t6 and a pressure-decreasing period (releasing period) T4 in which the wheel cylinder pressure Pwc as the predetermined holding pressure is decreased by the master cut solenoid valves 252A and 252B and the holding of the braking force is released is a period from the time t6 to the time t7.

Meanwhile, in the description of the time chart illustrated in FIG. 4, the control start judgment hydraulic pressure ThPmc as the control start judgment value is described as the value obtained by adding the set hydraulic pressure ΔP as the predetermined set amount to the vehicle stopping time hydraulic pressure Pmc1 at the time t2 at which the vehicle 100 stops. That is to say, the ECU 3 herein generates the braking force holding control command to execute the braking force holding control, when the brake operation in which the brake pedal 21 is depressed by the driver to stop the vehicle 100 and thereafter the brake pedal 21 is further depressed from this state beyond the predetermined set amount is detected as the predetermined brake operation by the driver. In other words, the ECU 3 executes the braking force holding control when an increasing amount of the master cylinder pressure Pmc from the vehicle stopping time hydraulic pressure Pmc1, which is the master cylinder pressure Pmc when the vehicle 100 stops, is larger than the set hydraulic pressure ΔP. That is to say, the set hydraulic pressure ΔP is herein a value corresponding to the control start judgment hydraulic pressure ThPmc as the control start judgment value, and when the increasing amount of the master cylinder pressure Pmc is larger than the set hydraulic pressure ΔP, the master cylinder pressure Pmc is also larger than the control start judgment hydraulic pressure ThPmc, so that to judge whether the increasing amount of the master cylinder pressure Pmc is larger than the set hydraulic pressure ΔP is to judge whether the master cylinder pressure Pmc is larger than the control start judgment hydraulic pressure ThPmc substantially. Therefore, the ECU 3 may judge whether the master cylinder pressure Pmc becomes larger than the control start judgment hydraulic pressure ThPmc to detect the predetermined brake operation or may judge whether the increasing amount of the master cylinder pressure Pmc becomes larger than the set hydraulic pressure ΔP to detect the predetermined brake operation.

The ECU 3 may also generate the braking force holding control command to execute the braking force holding control when the brake operation in which the brake pedal 21 is simply depressed by the driver beyond the control start judgment hydraulic pressure ThPmc is detected as the predetermined brake operation by the driver. That is to say, the control start judgment hydraulic pressure ThPmc as the control start judgment value may be set regardless of the vehicle stopping time hydraulic pressure Pmc1 at the time t2 at which the vehicle 100 stops and the set hydraulic pressure ΔP as the predetermined set amount.

In such braking apparatus 1, when the brake booster 24 fails due to deficiency of the negative pressure supplied to the brake booster 24, for example, increase in the pedal force by the brake booster 24 becomes smaller or the device is out of control, so that the master cylinder pressure Pmc generated corresponding to the pedal force in the master cylinder 22 might enormously decreases. Therefore, for example, when the brake booster 24 fails due to the deficiency of the negative pressure supplied to the brake booster 24, the pedal force larger than that when the brake booster 24 is in a normal state might be required in order to increase the master cylinder pressure Pmc to the control start judgment hydraulic pressure ThPmc. In other words, when the brake booster 24 fails, for example, the further depression of the brake pedal 21 might be difficult and operation of the control to hold the braking force might be difficult. Also, in this case, even in the operating condition in which the braking force holding control may be theoretically executed by depressing the brake pedal 21 by a predetermined amount, there is a case in which the braking force holding control may not be practically executed because the master cylinder pressure Pmc may not be actually increased by the brake booster 24, so that it might be required to activate a fail lamp, the slip indicator lamp 112 and the like, and drastic change in a computer program might be required, for example. Meanwhile, herein, a state in which the brake booster 24 fails is a state in which the pedal force input to the brake pedal 21 may not be increased, and a state in which the pedal force acting on the brake pedal 21 may not be doubled (increased) at the predetermined servo ratio because the negative pressure supplied from the engine 101 to the brake booster 24 is deficient or this is hardly supplied by trouble of the negative pressure piping 241 and the like, for example. Meanwhile, even in such a condition, there is not a large problem in basic operation of the braking apparatus 1.

Then, the braking apparatus 1 of this embodiment is provided with the ECU 3, which executes the braking force holding control to hold the braking force when the master cylinder pressure Pmc, which is the operation amount of the brake pedal 21 corresponding to the pedal force, becomes larger than the control start judgment hydraulic pressure ThPmc and sets the control start judgment hydraulic pressure ThPmc to be smaller than the control start judgment hydraulic pressure ThPmc in the normal state of the brake booster 24 when the brake booster 24 fails, and even when the increase in the pedal force by the brake booster 24 becomes smaller and the master cylinder pressure Pmc corresponding to the pedal force decreases when the brake booster 24 fails, the ECU 3 sets the control start judgment hydraulic pressure ThPmc so as to be smaller than the control start judgment hydraulic pressure ThPmc in the normal state of the brake booster 24, so that the braking force can be appropriately held.

Specifically, in the braking apparatus 1, as illustrated in FIG. 2, the ECU 3 is provided with a braking force holding controller 34, a master cut solenoid valve controller 35, a holding solenoid valve controller 36, a pressure-decreasing solenoid valve controller 37, a pump drive controller 38, a brake booster fail detecting unit 39 as a fail detecting means and a control start judgment value setting unit 40 as a judgment value setting means functionally and conceptionally, for example.

Herein, the ECU 3, which is composed mainly of the microcomputer, has a processing unit 31, a storage unit 32 and an input/output unit 33 connected to one another to be able to communicate signals. A drive circuit not illustrated for driving each unit of the braking apparatus 1, the above-described wheel speed sensors 51FL, 51FR, 51RL and 51RR, the various sensor such as the shift position sensor 52, the accelerator pedal sensor 53, the parking brake switch 54, the brake pedal sensor 55, the front-rear acceleration sensor 56, the inclination angle sensor 57 and the master cylinder pressure sensor 58 are connected to the input/output unit 33, and the input/output unit 33 inputs and outputs the signals between the same and the sensors. Also, the storage unit 32 stores the computer program for controlling each unit of the braking apparatus 1. The storage unit 32 can be composed of a hard disk device, a magneto-optical disk device, a non-volatile memory such as a flash memory (storage medium only capable of reading such as a CD-ROM) and a volatile memory such as a random access memory (RAM) or a combination of them. The processing unit 31 is composed of a memory and a central processing unit (CPU) not illustrated and has the above-described braking force holding controller 34, master cut solenoid valve controller 35, holding solenoid valve controller 36, pressure-decreasing solenoid valve controller 37, pump drive controller 38, brake booster fail detecting unit 39 as the fail detecting means and control start judgment value setting unit 40 as the judgment value setting means. The hill start aid control such as the braking force holding control and the braking force hold releasing control illustrated with reference to FIG. 5 are executed by the processing unit 31, which reads the computer program in the memory embedded in the processing unit 31 to calculate and transmits a control signal corresponding to a result of the calculation based on a detection result by the sensor provided on each unit. At that time, the processing unit 31 appropriately stores a value of the calculation in progress in the storage unit 32 and takes out the stored value to execute the calculation. Meanwhile, when controlling the braking apparatus 1, this may be controlled by a dedicated hard ware different from the ECU 3 in place of the computer program.

The braking force holding controller 34 generates the braking force holding control command and the braking force hold releasing control command for executing the hill start aid control such as the braking force holding control and the braking force hold releasing control. That is to say, the braking force holding controller 34 generates the braking force holding control command when the vehicle speed of the vehicle 100 detected by the wheel speed sensors 51FL, 51FR, 51RL and 51RR is 0 km/h, the turning off of the parking brake is detected by the parking brake switch 54, the turning off of the accelerator operation, that is to say, the turning off of the accelerator is detected by the accelerator pedal sensor 53 and the predetermined brake operation of the driver is detected, that is to say, when the master cylinder pressure Pmc detected by the master cylinder pressure sensor 58 becomes larger than the control start judgment hydraulic pressure ThPmc as described above. Also, the braking force holding controller 34 generates the braking force hold releasing control command when the predetermined time (for example, 2 seconds) has passed after the turning off of the brake operation, that is to say, the turning off of the brake is detected by the brake pedal sensor 55, when the turning on of the parking brake is detected by the parking brake switch 54, when the turning on of the accelerator is detected by the accelerator pedal sensor 53, or when the further depression of the brake pedal 21 by the driver is detected by the brake pedal sensor 55, as described above.

The master cut solenoid valve controller 35, the holding solenoid valve controller 36, the pressure-decreasing solenoid valve controller 37 and the pump drive controller 38 are means that control the brake actuator 25, and basically control the brake actuator 25 to realize target braking force based on the target braking force.

The master cut solenoid valve controller 35 controls the opening of each of the master cut solenoid valves 252A and 252B as described above. The master cut solenoid valve controller 35 sets the command current value so as to realize the target braking force based on the target braking force, in other words, based on the required pressurized pressure Pp, controls the current supplied to each of the master cut solenoid valves 252A and 252B based on the set command current value, and executes the opening control to control the opening, thereby adjusting the flow amount of the brake oil derived from the master cylinder 22 to adjust the pressurized pressure Pp.

Further, the master cut solenoid valve controller 35 also executes the braking force holding control by controlling the master cut solenoid valves 252A and 252B to be in the closed state when the vehicle 100 stops on the hill and the like. The master cut solenoid valve controller 35 controls the master cut solenoid valves 252A and 252B of the brake actuator 25 to be in the closed state based on the braking force holding control command generated by the braking force holding controller 34, thereby executing the braking force holding control to hold the wheel cylinder pressure Pwc from the master cut solenoid valves 252A and 252B to the wheel cylinders 26FL, 26FR, 26RL and 26RR side as the predetermined holding pressure.

The master cut solenoid valve controller 35 also executes the braking force hold releasing control by controlling the master cut solenoid valves 252A and 252B. The master cut solenoid valve controller 35 controls the master cut solenoid valves 252A and 252B of the brake actuator 25 to be in the opened state based on the braking force hold releasing control command generated by the braking force holding controller 34, thereby executing the braking force hold releasing control to decrease the wheel cylinder pressure Pwc as the holding pressure from the master cut solenoid valves 252A and 252B to the wheel cylinders 26FL, 26FR, 26RL and 26RR side.

That is to say, the master cut solenoid valve controller 35 is a means capable of executing the control to hold the braking force by the hydraulic braking apparatus 2 based on the operation of the brake pedal 21 and the like and a means capable of executing the control to release the holding of the braking force by the hydraulic braking apparatus 2 based on the operation of the accelerator pedal 101a and the like.

Meanwhile, the master cut solenoid valve controller 35 can herein adjust a pressure-decreasing speed of the wheel cylinder pressure Pwc held by the wheel cylinders 26FL, 26FR, 26RL, 26RR and the like, in other words, the pressure-decreasing period (releasing period) T4 by controlling the current supplied to the master cut solenoid valves 252A and 252B based on the command current value and executing the opening control to control the opening as described above.

The holding solenoid valve controller 36 controls the turning on and turning off of the holding solenoid valves 253FL, 253FR, 253RL and 253RR, as described above.

The pressure-decreasing solenoid valve controller 37 controls the turning on and turning off of the pressure-decreasing solenoid valves 254FL, 254FR, 254RL and 254RR, as described above.

The pump drive controller 38 drives each of the pressurizing pumps 256A and 256B by drive-controlling the driving motor 259. The pump drive controller 38 sets the command current value so as to realize the target braking force based on the above-described target braking force, in other words, based on the required pressurized pressure Pp, and drives the driving motor 259 based on the set command current value to drive-control the pressurized pumps 256A and 256B.

The brake booster fail detecting unit 39 detects the fail of the brake booster 24 and can detect the fail of the brake booster 24 by various well-known methods. The brake booster fail detecting unit 39 herein detects the fail of the brake booster 24 based on the pedal force to the brake pedal 21 detected by the brake pedal sensor 55 and the master cylinder pressure Pmc detected by the master cylinder pressure sensor 58, for example. That is to say, the brake booster fail detecting unit 39 compares the master cylinder pressure Pmc when the brake booster 24 normally operates and the pedal force increases with the master cylinder pressure Pmc actually detected by the master cylinder pressure sensor 58 relative to the pedal force input to the brake pedal 21, and when the actually detected master cylinder pressure Pmc is smaller than the master cylinder pressure Pmc in the normal state of the brake booster 24, this can detect the fail of the brake booster 24, for example, the deficiency of the negative pressure supplied to the brake booster 24. Meanwhile, relationship between the master cylinder pressure Pmc in the normal state of the brake booster 24 and the pedal force input to the brake pedal 21 may be stored in the storage unit 32 by creating a map from an experiment and the like in advance.

The control start judgment value setting unit 40 sets the control start judgment hydraulic pressure ThPmc as the control start judgment value based on a detection result of the brake booster fail detecting unit 39. That is to say, the control start judgment value setting unit 40 sets the control start judgment hydraulic pressure ThPmc to be smaller than the control start judgment hydraulic pressure ThPmc in the normal state of the brake booster 24 when the brake booster fail detecting unit 39 detects the fail of the brake booster 24. When the control start judgment value setting unit 40 sets the value obtained by adding the set hydraulic pressure ΔP to the vehicle stopping time hydraulic pressure Pmc1 as the control start judgment hydraulic pressure ThPmc, this sets the set hydraulic pressure ΔP to be smaller than the set hydraulic pressure ΔP in the normal state of the brake booster 24 when the brake booster fail detecting unit 39 detects the fail of the brake booster 24. According to this, the control start judgment value setting unit 40 changes the set hydraulic pressure ΔP to be smaller when the brake booster fail detecting unit 39 detects the fail of the brake booster 24, thereby substantially changing the control start judgment hydraulic pressure ThPmc to be smaller also.

Therefore, in the braking apparatus 1, even when the increase in the pedal force by the brake booster 24 becomes smaller and the master cylinder pressure Pmc corresponding to the pedal force decreases when the brake booster 24 fails, the control start judgment value setting unit 40 sets the control start judgment hydraulic pressure ThPmc or the set hydraulic pressure ΔP to be smaller than the control start judgment hydraulic pressure ThPmc or the set hydraulic pressureΔP in the normal state of the brake booster 24, so that even when the increase in the pedal force by the brake booster 24 is not sufficient, the master cylinder pressure Pmc can become larger than the control start judgment hydraulic pressure ThPmc set to be a relatively small value as compared to that in the normal state by the pedal force to the brake pedal 21 substantially as large as that in the normal state of the brake booster 24. As a result, even when the brake booster 24 fails, the operation of the braking force holding control can be started by depressing the brake pedal 21 with the pedal force substantially equal to that when the brake booster 24 normally operates, so that the braking force can be appropriately held. Also, according to this, it is not required to activate the fail lamp, the slip indicator lamp 112 and the like even when the brake booster 24 fails, for example, so that the drastic change in the computer program is not required.

Next, the hill start aid control of the braking apparatus 1 according to this embodiment is described with reference to the flow chart in FIG. 5. Meanwhile, a control routine is repeatedly executed with a controlling period of a few ms to several tens of ms.

First, the ECU 3 judges whether a system is authorized, that is to say, whether various drive circuits and various sensors of an entire system of the braking apparatus 1 including the hydraulic braking apparatus 2 for executing the hill start aid control normally operate (S100). When the system is not judged to be authorized (S100: No), the ECU 3 repeatedly executes the judgment until the system is judged to be authorized. When the system is judged to be authorized (S100: Yes), the braking force holding controller 34 of the ECU 3 judges whether the hill start aid control is authorized (S102). Herein, the braking force holding controller 34 judges whether the master cylinder pressure Pmc detected by the master cylinder pressure sensor 58 is not smaller than a certain value, for example, as an assumption of the hill start aid control. When the hill start aid control is not judged to be authorized (S102: No), the braking force holding controller 34 repeatedly executes the judgment until the hill start aid control is judged to be authorized.

When the hill start aid control is judged to be authorized (S102: Yes), the braking force holding controller 34 of the ECU 3 judges whether a hill start aid control operation authorization condition is established (S104). The braking force holding controller 34 herein judges whether the vehicle speed of the vehicle 100 detected by the wheel speed sensors 51FL, 51FR, 51RL and 51RR is 0 km/h, whether the turning off of the parking brake is detected by the parking brake switch 54, and whether the turning off of the accelerator is detected by the accelerator pedal sensor 53, and judges whether another control, which might interfere with the hill start aid control, is not executed, for example, as the hill start aid control operation authorization condition. When it is judged that the hill start aid control operation authorization condition is not established (S104: No), the braking force holding controller 34 repeatedly executes the judgment until it is judged that the hill start aid control operation authorization condition is established.

When it is judged that the hill start aid control operation authorization condition is established (S104: Yes), the brake booster fail detecting unit 39 of the ECU 3 judges whether the brake booster 24 fails based on the pedal force to the brake pedal 21 detected by the brake pedal sensor 55 and the master cylinder pressure Pmc detected by the master cylinder pressure sensor 58 (S106).

When it is judged that the brake booster 24 does not fail (S106: No), the control start judgment value setting unit 40 of the ECU 3 sets the control start judgment hydraulic pressure ThPmc to a normal state control start judgment hydraulic pressure ThPmc·A (approximately 7 MPa, for example) and the braking force holding controller 34 judges whether the master cylinder pressure Pmc detected by the master cylinder pressure sensor 58 is larger than the normal state control start judgment hydraulic pressure ThPmc·A (S108). On the other hand, when it is judged that the brake booster 24 fails (S106: Yes), the control start judgment value setting unit 40 of the ECU 3 sets the control start judgment hydraulic pressure ThPmc to a failed state control start judgment hydraulic pressure ThPmc·B (approximately 1 MPa, for example) sufficiently smaller than the normal state control start judgment hydraulic pressure ThPmc·A, and the braking force holding controller 34 judges whether the master cylinder pressure Pmc detected by the master cylinder pressure sensor 58 is larger than the failed state control start judgment hydraulic pressure ThPmc·B (S110).

When it is judged that the master cylinder pressure Pmc is not larger than the normal state control start judgment hydraulic pressure ThPmc·A (S108: No), or when it is judged that the master cylinder pressure Pmc is not larger than the failed state control start judgment hydraulic pressure ThPmc·B (S110: No), the procedure returns back to S104 to repeatedly execute a following process.

When it is judged that the master cylinder pressure Pmc is larger than the normal state control start judgment hydraulic pressure ThPmc·A (S108: Yes) or when it is judged that the master cylinder pressure Pmc is larger than the failed state control start judgment hydraulic pressure ThPmc·B (S110: Yes), the braking force holding controller 34 generates the braking force holding control command and calculates the road surface gradient of the road surface on which the vehicle 100 stops (S112). The braking force holding controller 34 can calculate the road surface gradient based on an inclination angle detected by the inclination angle sensor 57, the acceleration in the front-rear direction of the vehicle 100 detected by the front-rear acceleration sensor 56, a changing state of the rotational speed of each of the wheels 108 and 111 detected by the wheel speed sensors 51FL, 51FR, 51RL and 51RR, or the road surface gradient information (map information) obtained by using the navigation system and the global positioning system (GPS) receiver not illustrated, for example. The braking force holding controller 34 then calculates a required holding pressure corresponding to the braking force with which the vehicle 100 does not slide down the hill based on the road surface gradient calculated at S112 (S114).

The master cut solenoid valve controller 35 then starts the operation of the hill start aid control, which is the braking force holding control to hold the wheel cylinder pressure Pwc from the master cut solenoid valves 252A and 252B to the wheel cylinders 26FL, 26FR, 26RL and 26RR side at the required holding pressure calculated at S114, by controlling the master cut solenoid valves 252A and 252B of the brake actuator 25 to be in the closed state based on the braking force holding control command generated by the braking force holding controller 34 (S116).

Next, the braking force holding controller 34 judges whether to continue the hill start aid control (S118). The braking force holding controller 34 judges whether to continue the hill start aid control based on whether the predetermined time has passed after the turning off of the brake is detected by the brake pedal sensor 55, whether the turning on of the parking brake is detected by the parking brake switch 54, whether the turning on of the accelerator is detected by the accelerator pedal sensor 53, or whether further depression of the brake pedal 21 by the driver is detected by the brake pedal sensor 55, for example. When it is judged to continue the hill start aid control (S118: Yes), that is to say, when the predetermined time has not passed after the turning off of the brake is detected by the brake pedal sensor 55, the turning on of the parking brake is not detected by the parking brake switch 54, the turning on of the accelerator is not detected by the accelerator pedal sensor 53, and the further depression of the brake pedal 21 by the driver is not detected by the brake pedal sensor 55, the braking force holding controller 34 repeatedly executes the judgment until it is judged not to continue the hill start aid control.

When it is judged not to continue the hill start aid control (S118: No), that is to say, when the predetermined time has passed after the turning off of the brake is detected by the brake pedal sensor 55, when the turning on of the parking brake is detected by the parking brake switch 54, when the turning on of the accelerator is detected by the accelerator pedal sensor 53, or when the further depression of the brake pedal 21 by the driver is detected by the brake pedal sensor 55, the braking force hold releasing control command is generated. Then, the master cut solenoid valve controller 35 controls the master cut solenoid valves 252A and 252B of the brake actuator 25 to be in the opened state based on the braking force hold releasing control command generated by the braking force holding controller 34, thereby executing the braking force hold releasing control to decrease the wheel cylinder pressure Pwc as the holding pressure from the master cut solenoid valves 252A and 252B to the wheel cylinders 26FL, 26FR, 26RL and 26RR side (S120), and returns to S104 to repeatedly execute a following process.

The braking apparatus 1 according to the embodiment of the present invention described above is provided with the hydraulic braking apparatus 2 for increasing the pedal force to the brake pedal 21 by the brake booster 24 and generating the braking force exerted on the wheels 108 and 111 corresponding to the increased pedal force and is capable of holding the braking force when the vehicle 100 stops, and the ECU 3 for executing the braking force holding control to hold the braking force when the master cylinder pressure corresponding to the operation amount of the brake pedal 21 corresponding to the pedal force becomes larger than the control start judgment hydraulic pressure as the control start judgment value and setting the control start judgment hydraulic pressure so as to be smaller than the control start judgment hydraulic pressure in the normal state of the brake booster 24 when the brake booster 24 fails.

Therefore, since the ECU 3 is provided for executing the braking force holding control to hold the braking force when the master cylinder pressure corresponding to the operation amount of the brake pedal 21 corresponding to the pedal force becomes larger than the control start judgment hydraulic pressure and setting the control start judgment hydraulic pressure so as to be smaller than the control start judgment hydraulic pressure in the normal state of the brake booster 24 when the brake booster 24 fails, even when the increase in the pedal force by the brake booster 24 becomes smaller when the brake booster 24 fails and the master cylinder pressure corresponding to the pedal force decreases, the ECU 3 sets the control start judgment hydraulic pressure to be smaller than the control start judgment hydraulic pressure in the normal state of the brake booster 24, so that the braking force can be appropriately held.

Further, the braking apparatus 1 according to the embodiment of the present invention described above is provided with the brake pedal sensor 55 for detecting the pedal force input to the brake pedal 21 and the master cylinder pressure sensor 58 for detecting the master cylinder pressure as the operation amount of the brake pedal 21 corresponding to the pedal force, and the ECU 3 has the brake booster fail detecting unit 39 for detecting the fail of the brake booster 24 based on the pedal force detected by the brake pedal sensor 55 and the master cylinder pressure detected by the master cylinder pressure sensor 58 and the control start judgment value setting unit 40 for setting the control start judgment hydraulic pressure based on the detection result of the brake booster fail detecting unit 39. Therefore, the brake booster fail detecting unit 39 detects the fail of the brake booster 24 based on the pedal force and the master cylinder pressure and the control start judgment value setting unit 40 sets the control start judgment hydraulic pressure based on the detection result, so that the control start judgment hydraulic pressure can be set to be smaller than the control start judgment hydraulic pressure in the normal state of the brake booster 24 when the brake booster 24 fails.

Further, according to the braking apparatus 1 according to the embodiment of the present invention described above, the ECU 3 may set the value obtained by adding the set hydraulic pressure ΔP as the set amount to the master cylinder pressure when the vehicle 100 on which the hydraulic braking apparatus 2 is mounted stops as the control start judgment hydraulic pressure, and change the control start judgment hydraulic pressure by changing the set hydraulic pressure ΔP. In this case, the braking force holding control can be executed when the brake operation in which the brake pedal 21 is depressed by the driver to stop the vehicle 100 and thereafter the brake pedal 21 further depressed from this state beyond the set hydraulic pressure ΔP is detected, and the control start judgment hydraulic pressure can be substantially changed to be smaller by changing the set hydraulic pressure ΔP to be smaller when detecting the fail of the brake booster 24.

Further, according to the braking apparatus 1 according to the embodiment of the present invention described above, the hydraulic braking apparatus 2 has the master cylinder 22 for applying the master cylinder pressure to the brake oil corresponding to the pedal force, the hydraulic brake units 27FL, 27FR, 27RL and 27RR for generating the braking force by action of the wheel cylinder pressure Pwc based on the master cylinder pressure, and the master cut solenoid valves 252A and 252B capable of holding the wheel cylinder pressure Pwc and decreasing the held wheel cylinder pressure Pwc, and the ECU 3 executes the braking force holding control based on the master cylinder pressure, which is the operation amount of the brake pedal 21 corresponding to the pedal force. Therefore, the braking force holding control to hold the braking force when the master cylinder pressure corresponding to the operation amount of the brake pedal 21 corresponding to the pedal force becomes larger than the control start judgment hydraulic pressure as the control start judgment value can be executed, and the braking force holding control (hill start aid control) can be started corresponding to the request of the driver.

Meanwhile, the braking apparatus according to the embodiment of the present invention described above is not limited to the above-described embodiment and various changes can be made within the scope recited in claims.

The brake booster fail detecting unit 39 as the fail detecting means of the present invention is not limited to the method described above, and this may detect the fail of the brake booster 24 by the various methods. For example, the braking apparatus 1 is provided with negative pressure detecting means that detects the negative pressure supplied to the brake booster 24 and the brake booster fail detecting unit 39 may detect the fail of the brake booster 24 based on the negative pressure detected by the negative pressure detecting means. That is to say, the brake booster fail detecting unit 39 may detect the deficiency of the negative pressure supplied to the brake booster 24, that is to say, the fail of the brake booster 24 when the negative pressure detected by the negative pressure detecting means becomes lower than the negative pressure when the brake booster 24 normally operates. Also, the braking apparatus of the present invention may set the control start judgment value simply corresponding to the negative pressure without detecting the fail of the brake booster 24 when this is provided with the negative pressure detecting means as described above.

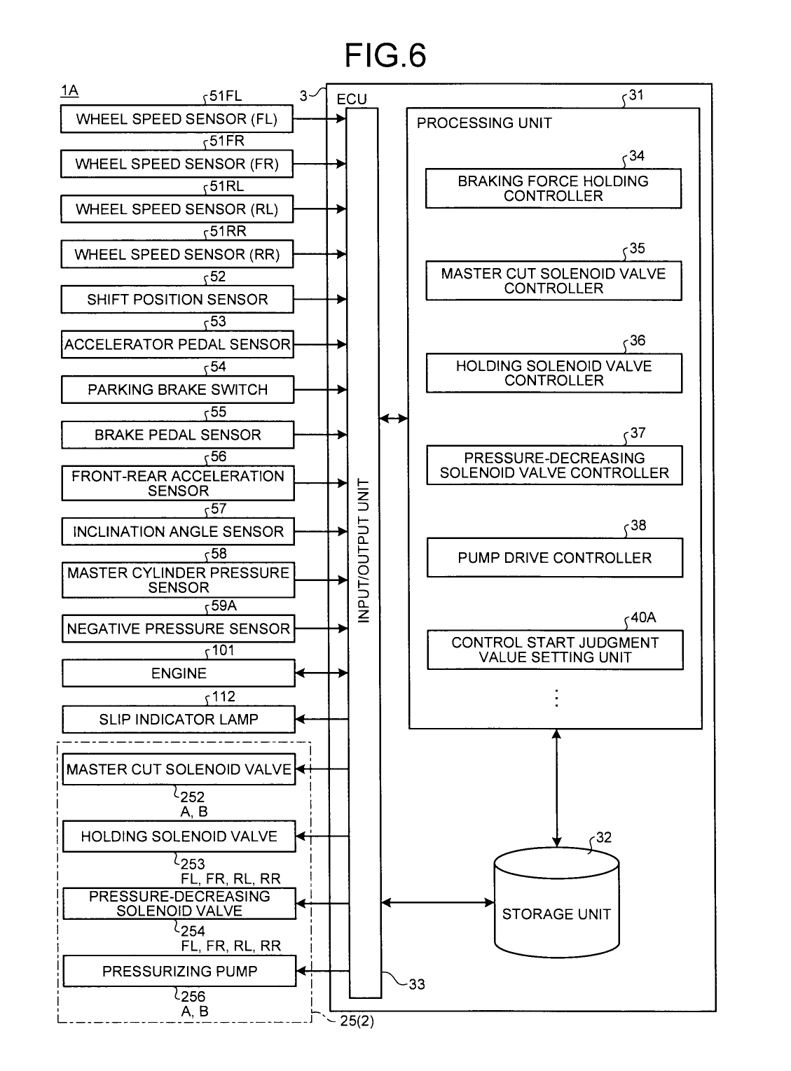

FIG. 6 is a block diagram illustrating the ECU of the braking apparatus according to a modified example of the present invention. Although a braking apparatus 1A according to this modified example has a configuration substantially similar to that of the braking apparatus 1 according to the embodiment, this differs from the braking apparatus 1 according to the embodiment in that this is provided with the negative pressure detecting means. In addition to this, as for the configuration, action and effect common to those of the above-described embodiment, the overlapping description is omitted as far as possible and the same reference numeral is given.

The braking apparatus 1A according to this modified example is provided with a negative pressure sensor 59A as the negative pressure detecting means. The negative pressure sensor 59A is provided in the middle of the negative pressure piping 241 (refer to FIG. 1). That is to say, the negative pressure sensor 59A detects the pressure in the negative pressure piping 241 as the negative pressure. The negative pressure sensor 59A is connected to the ECU 3 and a negative pressure Pv detected by the negative pressure sensor 59A is output to the ECU 3.

The ECU 3 of the braking apparatus 1A, which is not provided with the brake booster fail detecting unit 39 (refer to FIG. 2) described in the above-described embodiment, sets the control start judgment hydraulic pressure as the control start judgment value based on the negative pressure supplied to the brake booster 24. That is to say, the ECU 3 is provided with a control start judgment value setting unit 40A as the judgment value setting means, and the control start judgment value setting unit 40A is configured to set the control start judgment hydraulic pressure on a side on which the negative pressure detected by the negative pressure sensor 59A is small to a value smaller than the control start judgment hydraulic pressure on a side on which this is large.

That is to say, the braking apparatus 1A according to the modified example of the present invention described above is provided with the hydraulic braking apparatus 2 for increasing the pedal force to the brake pedal 21 by the brake booster 24 by using the negative pressure and generating the braking force to the wheels 108 and 111 corresponding to the increased pedal force and is capable of holding the braking force when the vehicle 100 stops, and the ECU 3 for executing the braking force holding control to hold the braking force when the master cylinder pressure corresponding to the operation amount of the brake pedal 21 corresponding to the pedal force becomes larger than the control start judgment hydraulic pressure as the control start judgment value and setting the control start judgment hydraulic pressure based on the negative pressure supplied to the brake booster 24.

Therefore, since the ECU 3 is provided for executing the braking force holding control to hold the braking force when the master cylinder pressure corresponding to the operation amount of the brake pedal 21 corresponding to the pedal force becomes larger than the control start judgment hydraulic pressure and setting the control start judgment hydraulic pressure based on the negative pressure supplied to the brake booster 24, even when the negative pressure supplied to the brake booster 24 is deficient due to the trouble of the negative pressure piping 241 and the like and the increase in the pedal force by the brake booster 24 becomes smaller and the master cylinder pressure corresponding to the operation amount of the brake pedal 21 corresponding to the pedal force decreases, the ECU 3 sets the control start judgment hydraulic pressure based on the negative pressure, so that the braking force can be appropriately held.

That is to say, the braking apparatus 1A according to the modified example of the present invention as described above is provided with the negative pressure sensor 59A for detecting the negative pressure supplied to the brake booster 24, and the ECU 3 has the control start judgment value setting unit 40A for setting the control start judgment hydraulic pressure on the side on which the negative pressure detected by the negative pressure sensor 59A is small to the value smaller than the control start judgment hydraulic pressure on the side on which this is large. Therefore, since the negative pressure sensor 59A detects the negative pressure supplied to the brake booster 24, and the control start judgment value setting unit 40A sets the control start judgment hydraulic pressure on the side on which the negative pressure is small to the value smaller than the control start judgment hydraulic pressure on the side on which this is large, even when the brake booster 24 does not completely fail, the control start judgment hydraulic pressure can be set in a more linear manner corresponding to variation in the negative pressure supplied to the brake booster 24 as compared to the case in which the fail of the brake booster 24 is detected and the control start judgment hydraulic pressure is set to be smaller when the brake booster 24 fails, for example, so that the pedal force until the master cylinder pressure Pmc increases to the control start judgment hydraulic pressure can be made substantially constant regardless of the negative pressure supplied to the brake booster 24, and it is possible to inhibit variation in feeling of the start operation of the braking force holding control by the driver from occurring.

Also, the braking apparatus of the present invention may estimate the negative pressure supplied to the brake booster 24 as the brake servo means from various parameters and may set the control start judgment value corresponding to the estimated negative pressure even when this is not provided with the above-described negative pressure detecting means.

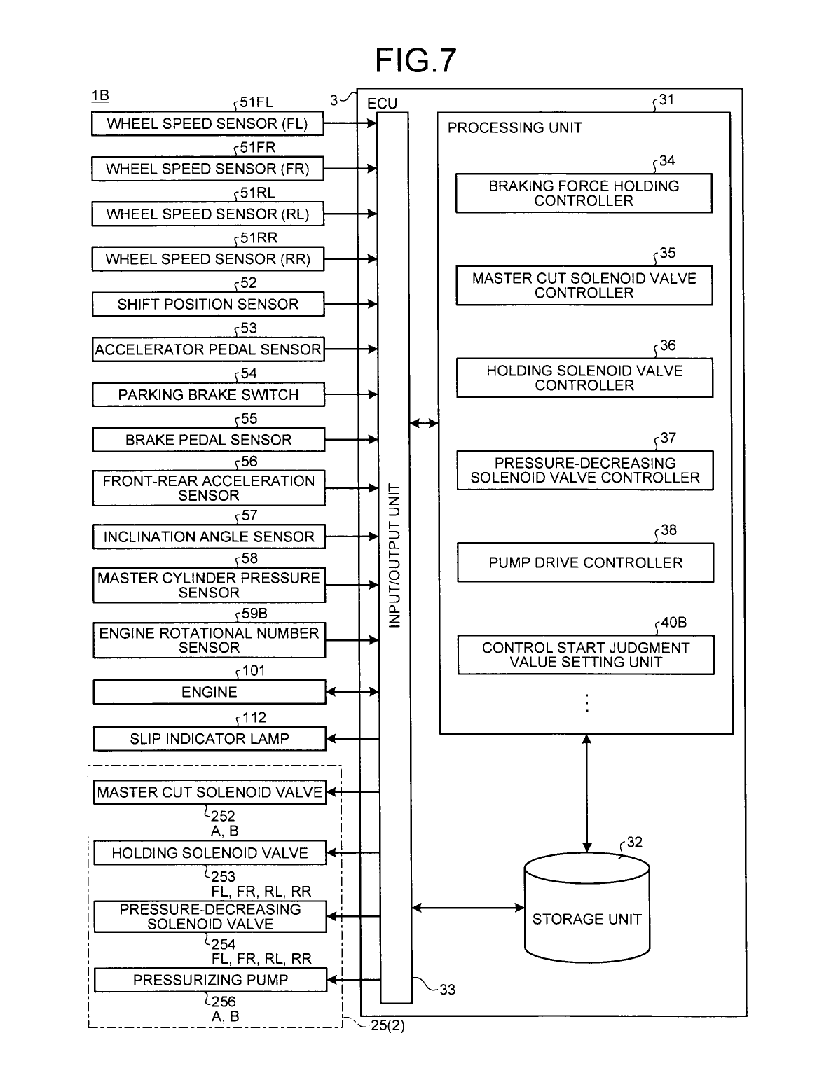

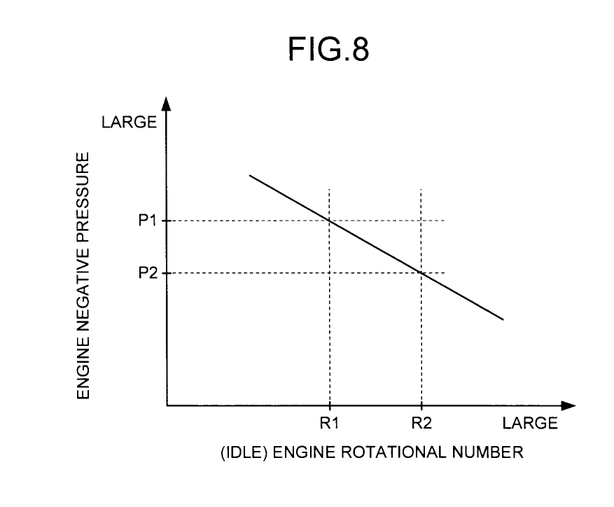

FIG. 7 is a block diagram illustrating the ECU of the braking apparatus according to another modified example of the present invention, and FIG. 8 is a diagram illustrating relationship between the engine rotational number and the engine negative pressure in the braking apparatus according to the modified example of the present invention. Although a braking apparatus 1B according to this modified example has a configuration substantially similar to that of the braking apparatus 1A according to the above-described modified example, this differs from the braking apparatus 1A according to the above-described modified example in that this is not provided with the negative pressure detecting means and estimates the negative pressure supplied to the brake servo means. In addition to this, as for the configuration, action and effect common to those of the above-described modified example, the overlapping description is omitted as far as possible and the same reference numeral is given.

The negative pressure is supplied from the intake route (intake passage) of the engine 101 through the negative pressure piping 241 (refer to FIG. 1) and the check valve 242 (refer to FIG. 1) to the brake booster 24 as the brake servo means, as described above. Herein, the braking apparatus 1B of this modified example estimates the negative pressure supplied to the brake booster 24 based on the rotational speed of the engine 101, that is to say, the engine rotational number. Herein, the braking apparatus 1B is provided with an engine rotational number sensor 59B as an internal combustion engine rotational speed detecting means in place of the above-described negative pressure sensor 59A (refer to FIG. 6).

The engine rotational number sensor 59B detects the engine rotational number as the rotational speed of the engine 101, which is the internal combustion engine. A crank angle sensor for detecting a crank angle of the engine 101 can be used as the engine rotational number sensor 59B, for example. The engine rotational number sensor 59B is connected to the ECU 3, and the crank angle (or the engine rotational number) detected by the engine rotational number sensor 59B is output to the ECU 3. The ECU 3 can distinguish an intake stroke, a compression stroke, an expansion stroke and an exhaust stroke in each cylinder based on the detected crank angle, and can calculate the engine rotational number (rpm) as the rotational speed of the engine.

The ECU 3 of this braking apparatus 1B, which is not provided with the brake booster fail detecting unit 39 (refer to FIG. 2) described in the above-described embodiment, sets the control start judgment hydraulic pressure as the control start judgment value based on the negative pressure supplied to the brake booster 24. Further, the ECU 3 herein estimates the negative pressure supplied to the brake booster 24 based on the engine rotational number. That is to say, the ECU 3 is provided with a control start judgment value setting unit 40B as the judgment value setting means, and the control start judgment value setting unit 40B estimates the negative pressure supplied to the brake booster 24 based on the engine rotational number detected by the engine rotational number sensor 59B.

The control start judgment value setting unit 40B estimates the engine negative pressure based on an engine negative pressure map illustrated in FIG. 8, for example. In the engine negative pressure map, the engine negative pressure and the engine rotational number are represented along the vertical axis and the horizontal axis, respectively. The engine negative pressure map depicts the relationship between the engine rotational number and the engine negative pressure. In the engine negative pressure map, the engine negative pressure generated in the intake route (intake passage) of the engine 101 becomes relatively smaller as the engine rotational number becomes relatively larger. That is to say, an engine negative pressure P2 corresponding to an engine rotational number R2 tends to be smaller than an engine negative pressure P1 corresponding to an engine rotational number R1 lower than the engine rotational number R2. The engine negative pressure map is stored in the storage unit 32 in advance. The control start judgment value setting unit 40B calculates the engine negative pressure from the engine rotational number detected by the engine rotational number sensor 59B based on the engine negative pressure map to estimate the negative pressure supplied to the brake booster 24 from the engine negative pressure. Meanwhile, although the control start judgment value setting unit 40B obtains the engine negative pressure by using the engine negative pressure map in this modified example, this modified example is not limited to this. The control start judgment value setting unit 40B may obtain the engine negative pressure based on an equation corresponding to the engine negative pressure map, for example.

Then, the control start judgment value setting unit 40B is configured to set the control start judgment hydraulic pressure on a side on which the estimated negative pressure is smaller to a value smaller than the control start judgment hydraulic pressure on a side on which this is large.

That is to say, the braking apparatus 1B according to the modified example of the present invention as described above is provided with the hydraulic braking apparatus 2 for increasing the pedal force to the brake pedal 21 by the brake booster 24 by using the negative pressure supplied from the intake route (intake passage) of the engine 101 and generating the braking force to the wheels 108 and 111 corresponding to the increased pedal force and is capable of holding the braking force when the vehicle 100 stops, and the ECU 3 for executing the braking force holding control to hold the braking force when the master cylinder pressure corresponding to the operation amount of the brake pedal 21 corresponding to the pedal force becomes larger than the control start judgment hydraulic pressure as the control start judgment value and setting the control starting judgment hydraulic pressure based on the engine rotational number of the engine 101.

Therefore, since the ECU 3 is provided for executing the braking force holding control to hold the braking force when the master cylinder pressure corresponding to the operation amount of the brake pedal 21 corresponding to the pedal force becomes larger than the control start judgment hydraulic pressure and estimating the negative pressure supplied to the brake booster 24 based on the engine rotational number to set the control start judgment hydraulic pressure based on the estimated negative pressure, even when the negative pressure supplied to the brake booster 24 is deficient due to the trouble of the negative pressure piping 241 and the like and the increase in the pedal force by the brake booster 24 becomes smaller and the master cylinder pressure corresponding to the operation amount of the brake pedal 21 corresponding to the pedal force decreases, for example, the ECU 3 sets the control start judgment hydraulic pressure based on the estimated negative pressure, so that the braking force can be appropriately held.

That is to say, according to the braking apparatus 1B according to the modified example of the present invention as described above, since the negative pressure is supplied from the intake route (intake passage) of the engine 101 to the brake booster 24 and the ECU 3 estimates the negative pressure supplied to the brake booster 24 based on the engine rotational number and sets the control start judgment hydraulic pressure on the side on which the estimated negative pressure is small to the value smaller than the control start judgment hydraulic pressure on the side on which this is large, even when the brake booster 24 does not completely fail, the control start judgment hydraulic pressure can be set in the more linear manner corresponding to the variation in the negative pressure supplied to the brake booster 24 as compared to the case in which the fail of the brake booster 24 is detected and the control start judgment hydraulic pressure is set to be small when the brake booster 24 fails, for example, so that the pedal force until the master cylinder pressure Pmc increases to the control start judgment hydraulic pressure can be made substantially constant regardless of the negative pressure supplied to the brake booster 24, and it is possible to inhibit the variation in the feeling of the start operation of the braking force holding control by the driver from occurring.

Meanwhile, although it is herein described that the control start judgment value setting unit 40B estimates the negative pressure supplied to the brake booster 24 based on the engine rotational number and sets the control start judgment hydraulic pressure based on the estimated negative pressure, this may be configured to set the control start judgment hydraulic pressure directly from the engine rotational number without estimating the negative pressure supplied to the brake booster 24.

Although it is described that the master cut solenoid valves 252A and 252B double as the holding means of the present invention capable of holding the braking pressure in the braking force holding control (hill start aid control) and the pressure-decreasing means of the present invention capable of decreasing the braking pressure held by the holding means, and the master cut solenoid valve controller 35 doubles as the means capable of executing the control to hold the braking force by the hydraulic braking apparatus 2 based on the operation of the brake pedal 21 and the means capable of executing the control to release the holding of the braking force by the hydraulic braking apparatus 2 based on the operation of the accelerator pedal 101a in the above description, there is no limitation.

For example, the holding means of the present invention capable of holding the braking pressure in the braking force holding control (hill start aid control) may be composed of the holding solenoid valves 253FL, 253FR, 253RL and 253RR, the pressure-decreasing means of the present invention capable of decreasing the braking pressure held by the holding means may be composed of the pressure-decreasing solenoid valves 254FL, 254FR, 254RL and 254RR, the means capable of executing the control to hold the braking force by the hydraulic braking apparatus 2 based on the operation of the brake pedal 21 may be composed of the holding solenoid valve controller 36, and the means capable of executing the control to release the holding of the braking force by the hydraulic braking apparatus 2 based on the operation of the accelerator pedal 101a may be composed of the pressure-decreasing solenoid valve controller 37.

### INDUSTRIAL APPLICABILITY

As described above, the braking apparatus according to the present invention is capable of appropriately hold the braking force and is suitable to be used in the various braking apparatuses.

1. A braking apparatus, comprising:
a braking unit that increases operating force to a brake operating member by a brake servo unit, generates braking force exerted on wheels corresponding to the increased operating force, and is capable of holding the braking force when a vehicle stops; and
a controlling unit that executes braking force holding control to hold the braking force when an operation amount of the brake operating member corresponding to the operating force becomes larger than a control start judgment value, and sets the control start judgment value to be smaller than the control start judgment value in a normal state of the brake servo unit when the brake servo unit fails.

2. The braking apparatus according to claim 1, further comprising:
an operating force detecting unit that detects the operating force input to the brake operating member; and
an operation amount detecting unit that detects an operation amount of the brake operating member corresponding to the operating force, wherein
the controlling unit has a fail detecting unit that detects fail of the brake servo unit based on the operating force detected by the operating force detecting unit and the operation amount detected by the operation amount detecting unit, and a judgment value setting unit that sets the control start judgment value based on a detection result of the fail detecting unit.

3. A braking apparatus, comprising:
a braking unit that increases operating force to a brake operating member by a brake servo unit by using a negative pressure, generates braking force exerted on wheels corresponding to the increased operating force, and is capable of holding the braking force when a vehicle stops; and
a controlling unit that executes braking force holding control to hold the braking force when an operation amount of the brake operating member corresponding to the operating force becomes larger than a control start judgment value, and sets the control start judgment value based on a negative pressure supplied to the brake servo unit.

4. The braking apparatus according to claim 3, further comprising:
a negative pressure detecting unit that detects a negative pressure supplied to the brake servo unit, wherein
the controlling unit has a judgment value setting unit that sets the control start judgment value on a side on which the negative pressure detected by the negative pressure detecting unit is small to a value smaller than the control start judgment value on a side on which the negative pressure is large.

5. The braking apparatus according to claim 3, wherein
the negative pressure is supplied from an intake passage of an internal combustion engine to the brake servo unit,
the controlling unit has a judgment value setting unit that estimates a negative pressure supplied to the brake servo unit based on a rotational speed of the internal combustion engine, and sets the control start judgment value on a side on which the negative pressure is small to a value smaller than the control start judgment value on a side on which the negative value is large.

6. A braking apparatus, comprising:
a braking unit that increases operating force to a brake operating member by a brake servo unit by using a negative pressure supplied from an intake passage of an internal combustion engine, generates braking force exerted on wheels corresponding to the increased operating force, and is capable of holding the braking force when a vehicle stops; and
a controlling unit that executes braking force holding control to hold the braking force when an operation amount of the brake operating member corresponding to the operating force becomes larger than a control start judgment value, and sets the control start judgment value based on a rotational speed of the internal combustion engine.

7. The braking apparatus according to claim 1, wherein
the controlling unit sets a value obtained by adding a set amount to the operation amount when the vehicle on which the braking unit is mounted stops as the control start judgment value, and changes the control start judgment value by changing the set amount.

8. The braking apparatus according to claim 1, wherein
the braking unit has an operating pressure applying unit that applies an operating pressure to operating fluid corresponding to the operating force, a braking force generating unit that generates the braking force by action of a braking pressure based on the operating pressure, a holding unit capable of holding the braking pressure, and a pressure-decreasing unit capable of decreasing the braking pressure held by the holding unit, wherein
the controlling unit executes the braking force holding control based on the operating pressure being an operation amount of the brake operating member corresponding to the operating force.

9. The braking apparatus according to claim 2, wherein
the controlling unit sets a value obtained by adding a set amount to the operation amount when the vehicle on which the braking unit is mounted stops as the control start judgment value, and changes the control start judgment value by changing the set amount.

10. The braking apparatus according to claim 3, wherein
the controlling unit sets a value obtained by adding a set amount to the operation amount when the vehicle on which the braking unit is mounted stops as the control start judgment value, and changes the control start judgment value by changing the set amount.

11. The braking apparatus according to claim 4, wherein
the controlling unit sets a value obtained by adding a set amount to the operation amount when the vehicle on which the braking unit is mounted stops as the control start judgment value, and changes the control start judgment value by changing the set amount.

12. The braking apparatus according to claim 5, wherein
the controlling unit sets a value obtained by adding a set amount to the operation amount when the vehicle on which the braking unit is mounted stops as the control start judgment value, and changes the control start judgment value by changing the set amount.

13. The braking apparatus according to claim 6, wherein
the controlling unit sets a value obtained by adding a set amount to the operation amount when the vehicle on which the braking unit is mounted stops as the control start judgment value, and changes the control start judgment value by changing the set amount.

14. The braking apparatus according to claim 2, wherein
the braking unit has an operating pressure applying unit that applies an operating pressure to operating fluid corresponding to the operating force, a braking force generating unit that generates the braking force by action of a braking pressure based on the operating pressure, a holding unit capable of holding the braking pressure, and a pressure-decreasing unit capable of decreasing the braking pressure held by the holding unit, wherein
the controlling unit executes the braking force holding control based on the operating pressure being an operation amount of the brake operating member corresponding to the operating force.

15. The braking apparatus according to claim 3, wherein
the braking unit has an operating pressure applying unit that applies an operating pressure to operating fluid corresponding to the operating force, a braking force generating unit that generates the braking force by action of a braking pressure based on the operating pressure, a holding unit capable of holding the braking pressure, and a pressure-decreasing unit capable of decreasing the braking pressure held by the holding unit, wherein
the controlling unit executes the braking force holding control based on the operating pressure being an operation amount of the brake operating member corresponding to the operating force.

16. The braking apparatus according to claim 4, wherein
the braking unit has an operating pressure applying unit that applies an operating pressure to operating fluid corresponding to the operating force, a braking force generating unit that generates the braking force by action of a braking pressure based on the operating pressure, a holding unit capable of holding the braking pressure, and a pressure-decreasing unit capable of decreasing the braking pressure held by the holding unit, wherein
the controlling unit executes the braking force holding control based on the operating pressure being an operation amount of the brake operating member corresponding to the operating force.

17. The braking apparatus according to claim 5, wherein
the braking unit has an operating pressure applying unit that applies an operating pressure to operating fluid corresponding to the operating force, a braking force generating unit that generates the braking force by action of a braking pressure based on the operating pressure, a holding unit capable of holding the braking pressure, and a pressure-decreasing unit capable of decreasing the braking pressure held by the holding unit, wherein
the controlling unit executes the braking force holding control based on the operating pressure being an operation amount of the brake operating member corresponding to the operating force.

18. The braking apparatus according to claim 6, wherein
the braking unit has an operating pressure applying unit that applies an operating pressure to operating fluid corresponding to the operating force, a braking force generating unit that generates the braking force by action of a braking pressure based on the operating pressure, a holding unit capable of holding the braking pressure, and a pressure-decreasing unit capable of decreasing the braking pressure held by the holding unit, wherein
the controlling unit executes the braking force holding control based on the operating pressure being an operation amount of the brake operating member corresponding to the operating force.

19. The braking apparatus according to claim 7, wherein
the braking unit has an operating pressure applying unit that applies an operating pressure to operating fluid corresponding to the operating force, a braking force generating unit that generates the braking force by action of a braking pressure based on the operating pressure, a holding unit capable of holding the braking pressure, and a pressure-decreasing unit capable of decreasing the braking pressure held by the holding unit, wherein
the controlling unit executes the braking force holding control based on the operating pressure being an operation amount of the brake operating member corresponding to the operating force.
